(19) United States
(12) Patent Application Publication
(10) Pub. No.: US 2006/0248206 A1
(43) Pub. Date: Nov. 2, 2006

(54) Remote service invocation in heterogeneous networks

(76) Inventors: Adriaan Jan Moerdijk, Rijen (NL); Johannes Van Elburg, Oosterhout (NL); Paulus Karremans, Tilburg (NL); Eltjo Boersma, Eindhoven (NL); Alejandro Bascunana-Munoz, Torrevieja (ES)

Correspondence Address: ERICSSON INC., 6300 LEGACY DRIVE, M/S EVR C11, PLANO, TX, 75024, US

(21) Appl. No.: 10/533,327

(22) PCT Filed: Apr. 1, 2003
(86) PCT No.: PCT/SE03/00520

§ 371 Date: Jan. 13, 2006

(30) Foreign Application Priority Data
Nov. 5, 2002 (SE) 0203297-7

(51) Int. Cl. G06F 15/16

(52) U.S. Cl. 709/230

(57) ABSTRACT

The invention provides a system and a method for providing those client applications having access to services in a first domain with access to services in another domain via a standardized interface such as the one specified under OSA/PARLAY standardization bodies. Therefore, in accordance with the invention, there is provided a framework-to-framework interface whereby a number of domains are enabled to offer services to another number of domains, and whereby a particular first framework in a first domain can proceed to discover available service enablers in other domains via corresponding second frameworks in said other domains. Thus, in accordance with the invention, a first domain is enabled to offer services to its client applications from a second domain in addition to those services already offered by said first domain itself. In addition the invention expands the system and method with ways to specify, communicate and enforce the agreements between the domains involved.

### FIELD OF THE INVENTION

The present invention generally relates to the inter-working and compatibility between services offered by a core network and applications residing at a service network. In particular, the invention relates to the development of an open standard interface between a core network and a service network, as well as between a number of core networks.

### BACKGROUND

Today, big players in the telecommunication market have several types of access and core networks technologies distributed along the countries were they operate for providing the users with access to telecom networks and to Internet. Exemplary technologies of the types commented above, such as GPRS, EDGE, CDMA, TDMA, D-AMPS, PDC, CDMA-2000, WCDMA, etc., as well as combinations thereof derive in different scenarios where different heterogeneous environments turn up. Thus, apart from the complexity introduced by such heterogeneous environments, the administrative divisions among these networks into several local companies adds even more heterogeneity to the environment and makes the provisioning of unified services and service application accesses to users roaming through different core networks or different network domains more complex.

New competitors are emerging now to operate networks out of the traditional telecom premises. These new competitors nowadays are a part of the telecommunications market, especially in all issues related to data transmission, while allowing roaming, wider broadband access than conventional PLMN networks, and adding other value added services to users. These companies may operate several types of networks as well, such as small WLAN local operators, Satellite operators, cable operators, etc.

In such a market scenario for telecommunication network, old and new network operators have their own customer base, and therefore the efforts to develop applications and services are more complex than before due to the great diversity of technology and administrative environments. In facing this complexity, telecommunication networks are currently perceived as comprising a service layer, a control layer, and a connectivity layer. The service layer is generally understood as a network environment intended for the development and operation of high level application and, more particularly, end-users service applications. The connectivity layer provides the necessary infrastructure, or network resources, required for establishing an end-to-end connection. The control layer provides the required infrastructure, network control entities, for controlling those network resources in the connectivity layer while providing the service layer with the necessary network support for running end-users service applications. A next step has been introduced in order to develop personalized service quickly and easily by suggesting a network architecture such that the service application layer is realized as a separate network, the Service Network, whereas the control and connectivity layer remain in a Core Network inter-working with an Access Network.

The interaction and compatibility among service layers and control layers in heterogeneous environments have to be solved in order to provide a user with a true Virtual Home Environment (VHE) for allowing a personalized service portability across network boundaries and between terminals. The concept of VHE is such that users are consistently presented with the same personalized features, user interface customization and services in whatever network and whatever terminal, wherever the user may be located, that is, independently of the access and core networks where such users currently hold a subscription and where they are presently roaming. In this respect, remote service invocation and service network roaming appear as key factors for allowing the users to have a true Virtual Home Environment.

One exemplary instance of the efforts made nowadays to standardize an Open Service Access (OSA) interface between the service network layer and the core network layer are the Parlay/OSA specifications, which are based on a number of Application Programming Interfaces (APIs). These APIs allow developers to access the services offered by the core network in an easy way.

A set of initial Application Programming Interfaces (APIs) were defined within the so-called Parlay group, and their standardization goes on under the 3^{rd} Generation Partnership Project (3GPP) and European Telecommunication Standard Institute (ETSI) standardization bodies. In this context, the service network concept along with the above APIs are traditionally referred to as “Parlay” within the Parlay group whereas 3GPP and ETSI usually refer them as “Open Service Access” (OSA). For the sake of clarity, the term OSA/PARLAY is currently used throughout this instant specification for referring the interface layer between the core and the service networks shown in FIG. 1. Nowadays, a close cooperation on specifying and standardizing OSA/PARLAY APIs exists between Parlay, 3GPP, and ETSI, and most of the work is done jointly.

Thus, OSA/PARLAY allows users and developers to access and to offer applications using services offered by the operator's core home network. The aim is that the above APIs are network independent, thus enabling the evolution of core networks technologies without impacts on the applications, as well as allowing applications to work with different types of core networks.

Therefore and shown in FIG. 2A, a conventional architecture based on OSA/PARLAY comprises Client Applications that are formally included in a service network and deployed on Application Servers (AS), a number of Service Capability Features (SCF) representing interface classes of the OSA/PARLAY interface and implemented in Service Capability Servers (SCS) also called Service Enablers, an OSA/PARLAY Framework (FW) for providing (S-10) framework capabilities to Applications such as a controlled access (S-30) to the Service Capability Features, and Core Network elements (CN). In particular, the Applications running on Application Servers (AS) use (S-20) the Service Capability Features provided by the Service Capability Servers (SCS), and thus the SCS implements the server side of the API whereas the AS implements the client side. The SCS may interact (S-40) with Core Network elements such as the Home Location Register (HLR), Mobile Switching Center (MSC), Call Status Control Function (CSCF), etc.

Client Applications access OSA/PARLAY functions in terms of service capability features via a standardized application interface. This means that service capability features are accessible and visible to client applications via invocation of operations in the OSA/PARLAY API interface.

The above OSA/PARLAY functions have been generally grouped on three different types to distinguish:
Framework functions, for providing commonly used utilities, necessary for access control, security, resilience and management of OSA/PARLAY functions;
Network functions, for enabling the applications to make use of the functionality of the underlying network capabilities; and
User data related functions, for enabling applications to access data of a particular user, such as the status of the user, location, or data in a corresponding user Profile.

In particular, the Framework provides the essential capabilities that allow OSA/PARLAY applications to make use of the service capabilities in the Home network, and more specifically Security Management including Authentication and Authorization, Service Registration and Discovery functions, and Integrity Management.

Regarding the operations in the OSA/PARLAY API interface commented above, three types of interface classes have been distinguished:
interface classes (S-10) between the Applications in the service network and the Framework for providing the applications with basic mechanisms, like Authentication for instance, that enable said Applications to make use of the service capabilities in the home network;
interface classes (S-20) between Applications and Service Capability Features (SCF), which are individual services available to the Applications once such interface class (S-20) is obtained (S-10) from the Framework; and

interface classes (S-30) between the Framework and the Service Capability Features that provide mechanisms for supporting multi-vendor environment.

Nevertheless, and as FIG. 3A illustrates, there is no way to run the execution (S-45) of an application (AS-1, SCS-1) in a user's Home Network that comprises a number of Client Applications (AS-1), a Framework (FW-1), a number of Service Capabilities (SCS-1) and a first core network (CN-1), where said application (AS-1, SCS-1) makes use of Service Capabilities (SCS-2) in a Visited Network comprising a number of Client Applications (AS-2), a Framework (FW-2), Service Capabilities (SCS-2) and a second core network (CN-2) through the OSA/PARLAY interface, wherein said Home Network and said Visited Network belong to different domain operators, and wherein said Service Capabilities (SCS-2) of the Visited Network are not registered in the Home Network.

The OSA/PARLAY model commented above can be variably distributed among different players in such manners that different administrative and business domains turn up. Some exemplary models are presented in FIGS. 2B and 2C wherein, in particular, an Enterprise Operator represents itself another domain acting on behalf of an Application toward a Network Domain operator.

Certain operators are organized in such a way that there is an organization responsible for the core network as well as for in-house developed end-user services and applications, whereas another separate organization is responsible for providing end-user services through partners as well as for offering service capabilities to said partners as FIG. 2B shows. Such above different organizations imply somewhat different telecommunication domains (Core Network domain, End-user Service domain, Partners) that need to independently enforce their own policies and to gather their own service information. Thus, these different telecommunication domains would get respective advantages of offering service capabilities from the other domain in addition to those service capabilities offered by each domain itself, and this has been recently known in certain fora as a “Federation”. In other words, different organizations, even different corporate firms, might get additional advantages of having a flexible solution where a second domain, namely a Donor Domain, can offer service capabilities toward a first domain, namely a Receiver Domain, that in turn can offer these said capabilities to its own partners, namely its own service providers. Furthermore, under some business oriented scenarios, there exists the role of Enterprise Operator in charge of retailing network services. Such Enterprise Operator role, as illustrated in FIG. 2C, allows service agreements to be set up (A-11) in a service domain between said Enterprise Operator (EO) and Application Providers (AP). The Enterprise Operator is also bounded by a service agreement (A-10), namely a Service Contract, with a Network Domain Operator (NDO) offering its particular Service Enablers (SCS).

Nevertheless, there are no means nowadays for a Network Domain Operator to offer Service Enablers of another domain to those application providers with which said network domain operator has a service agreement. As shown in FIG. 3B, the architectural and interfacing model, which OSA/PARLAY has focused on, does not provide (S-25) for a second domain (NDO-2) offering its service capabilities (SCS-2) to a first domain (NDO-1) and vice versa, and neither does it where any of these domains (NDO-1; NDO-2) has its own partners (AP-1, EO-1; AP-2, EO-2) for offering the corresponding applications Service Level Agreements (A-10, A-11), namely policies, that may be enforced during a run-time service execution.

In this respect, an object of the present invention is to provide means and methods for enabling the execution of an application in a user's home network that makes use of network services from a network in another domain, such as a visited network, through the OSA/PARLAY interface, wherein said user's home network and said visited network belong to different domain operators, and said network services are not registered in the user's home network.

Another object of the present invention is to enable a domain offering service capabilities from another domain in addition to those offered by each domain itself.

### SUMMARY OF THE INVENTION

The above objects, among others, are accomplished in accordance with the invention by the provision of a telecommunication system and a method for providing client service applications with access to service capability features via a standardized interface. In particular, the telecommunication system and the method are applicable in scenarios where a standardized interface, like the one provided by OSA/PARLAY API, exists between a service network and a core network under a number of different network domains.

The telecommunication system thus comprises a number of application servers where client service applications run, a number of first service enablers, namely first service capability servers where first service capability features are specified in a first (receiver) network domain, a first Framework for providing a controlled access to said first service capability features, and a number of core network elements inter-working with entities of the service network.

Generally speaking, a framework may be regarded as a functional Framework entity intended for carrying out the Framework functions described above in respect of the OSA/PARLAY standards, as well as new framework functions provided in accordance with the present invention and further described. On the other hand, for the purpose of the present invention a service enabler can be regarded as a service capability server (SCS) where service capability features (SCF) are specified in a certain network domain. For the sake of simplicity, references are made throughout this document to service capability features, or to service enablers or to service capability servers depending on the particular context without always relating to each other.

Thus, in accordance with the present invention, said first Framework in this telecommunications system is arranged for communicating with at least one second Framework, the latter intended for accessing second service capability features specified in a number of second service enablers of a second (donor) network domain.

For the sake of clarity, the invention often refers to a Donor domain as the network domain that offers its service enablers to another domain, or rather those service capability features specified in said service enablers. In this respect, the invention often refers to a Receiver domain as the network domain enabled to use service enablers provided by a Donor Domain.

The frameworks in this telecommunication system are given protocol means for allowing a framework-to-framework communication. Such protocol means include means for advertising toward a first framework in a first network domain the existence of a second framework in a second network domain with which service capability features can be shared. The protocol means also include means for advertising from a second framework in a second network domain toward a first framework in a first network domain that service capability features can be offered from service enablers of said second network domain to client applications of said first network domain.

Moreover, the means for advertising the existence of other frameworks in other domains includes means for each framework registering by itself in another framework. Apart from this self registration, or alternatively, the means for advertising toward a first framework in a first domain the existence of a second framework in a second domain includes means for the operator of said first domain registering the second framework in the first framework as well as means for the operator of said second domain registering the first framework in the second framework.

Further, the means for advertising service capability features that can be offered from service enablers of a second network domain includes means for notifying from a second framework in said second network domain toward a first framework in a first network domain service information about at least one element of service information selected from a group of elements that comprises: service identifier, service type, service availability, service properties and service interface.

Moreover, the means for advertising the existence of available service capability features in a second network domain includes means for creating, from a first framework in the first network domain toward a second framework in a second network domain, criteria for notification of such element of service information.

The telecommunication system further comprises means for carrying out security management mechanisms between the first framework in said first network domain and the second framework in said second network domain. Said means for carrying out security management mechanisms includes means for capturing service agreements between first and second domains. These service agreements specify the conditions on which the first domain can let its receiver client applications make use of the service capabilities in the second domain, and specify the obligations on which the second domain can supply the service capabilities to the first domain. These service agreements may be thus considered a policy applied between said first and second domains. In addition, or alternatively, to the above means for capturing service agreements, means for handing over service assertions and signatures may be also included within the means for carrying out security management mechanisms between the first framework and the second framework.

More specifically, this telecommunications system also comprises means for discovering service capability features available at service enablers of a second network domain between a first framework in a first network domain and a second framework in said second network domain. This includes means for negotiating specific capabilities as required by a client application in said first domain. Once these specific capabilities have been successfully negotiated, the telecommunication system includes means for returning from the second framework toward the first framework a reference to a service instance created at a service enabler of the second network domain for allowing the client application in the first network domain make use of corresponding service of the second network domain.

Still further, the telecommunications system also comprises a Service Enabler Proxy interposed between the first (Receiver) domain and the second (Donor) domain, said Service Enabler Proxy intended for acting as a Proxy for service requests from those applications in the first domain toward service enablers of the second domain, as well as communications in the opposite direction. The Service Enabler Proxy is preferably provided in the first (Receiver) domain and may comprise a number of dedicated service capability features of said first domain for storing references of corresponding service capability features of a second (Donor) domain. Therefore, the telecommunications system may comprise further means for creating a Service Enabler Proxy automatically in the first (Receiver) domain based on information received from a framework (Donor Framework) in a second (Donor) domain, said information including at least one element of service information selected from a group of elements that comprises: service identifier, service type, service availability, service properties and service interface. Alternatively, the telecommunications system may comprise further means for creating a Service Enabler Proxy by downloading code, for example source code or run-time code, from the second (Donor) domain. The telecommunications system may comprise alternative means for creating a Service Enabler Proxy by registering a particular service enabler of the second (Donor) domain in the first framework of the first (Receiver) domain, said particular service enabler for acting as Service Enabler Proxy towards the second (Donor) domain.

The telecommunications system presented herein accomplishes the objects of the invention stated above and, in particular, the first (Receiver) network domain may include the Home core network of a user whereas the second (Donor) network domain may comprise a Visited core network where the user is roaming.

A method is also provided by the present invention for providing client service applications with access to service capability features via a standardized interface (OSA/PARLAY API), the method comprising the steps of:
registering first service capability features in a first (Receiver) network domain with a first Framework and second service capability features in a second (Donor) network domain with a second Framework;
carrying out security management mechanisms for authentication and authorization of a number of players selected from a group that includes user, network, a requester application, and combinations thereof, in each network domain through each respective Framework; and
discovering first service capability features that are available for use by a requester application in said first (Receiver) network domain.

The method also including in accordance with the invention the steps of:
determining in the first (Receiver) network domain that second service capability features at a second (Donor) network domain may be available for the requester application;
carrying out security management mechanisms for authentication and authorization from a first Framework of said first (Receiver) network domain, through a second Framework of said second (Donor) network domain; and
discovering second service capability features (SCF-2) that are available for use by said requester application in said second (Donor) network domain.

The method, in order to determine that second service capability features are available at a second network domain, further includes a step of requesting to the first Framework in the first (Receiver) network domain for access to the second service capability features available in the second (Donor) network domain. The determination may include an additional step of receiving such information from a first service capability feature selected in the first (Receiver) network domain.

Moreover, the step of discovering second service capability features that are available in the second (Donor) network domain in this method may also comprise a step of negotiating capabilities from the first Framework of the first (Receiver) network domain with the second Framework of the second (Donor) network domain. More particularly, the step of negotiating capabilities includes a step of creating an instance of a selected second service capability feature at a service enabler of the second (Donor) domain, and a step of returning back a reference to such instance from the second Framework to the first Framework.

An advantageous behavior is achieved when the method also comprises a step of registering a second Framework of a second (Donor) network domain with a first Framework of a first (Receiver) network domain. This registration includes a first step of registering the second Framework itself in the first Framework, and a second step of registering the first Framework itself in the second Framework. Apart from this self registration, or alternatively, the method may also comprise a first step where the operator of the second (Donor) network domain registers the first Framework of the first (Receiver) network domain in the second Framework, and a second step where the operator of the first (Receiver) network domain registers the second Framework of the second (Donor) network domain in the first Framework. Independently of using the self registration or the operator initiated registration, the method further comprises a step of publishing at least one interface that allows said first and said second Frameworks to access the service capability features respectively controlled by each other.

Service enablers at any particular domain may be upgraded with new or amended service capability features from time to time. There is indeed a need for updating corresponding service information throughout all domains where said service capability features are registered. Therefore, the method further comprises a step of exchanging information between a first and a second Framework about available service capability features in a first and a second network domain respectively, with or without explicit indication of the interface required to access such service capability features. In particular, when dedicated service capability features in a first network domain are responsible for determining that second service capability features are available in a second network domain, the method includes a step of indicating to at least one first service capability feature in the first network domain the at least one second service capability feature available in the second network domain, and likely a step of storing corresponding information in such dedicated service capability feature in the first network domain.

Additional advantages can be obtained by including in this method a step of capturing Service Level Agreements between the network operator of a network domain and a service provider of a requester application. Aligned with this, the method also comprises a step of capturing Service Level Agreements between a first and a second network domains through corresponding first and second Frameworks.

Thereby, said Service Level Agreements are extended between second (Donor) domains and first (Receiver) domains in such a manner that the method may further comprise the steps of:
creating and assigning a Federation Service Profile on a Donor Framework;
signing a Federation Service Agreement on a Donor Framework;
installing (registering) in a Receiver Framework necessary information about a Donor Service for a client application being able to discover the Donor Service; and
requesting a Receiver Application Service Agreement within the bounds of a Federation Service Agreement from a Donor Framework.

A more advantageous security management mechanism can be achieved by including a step of handing out and handing over an Assertion that gives a practitioner the right to use a service in a federated framework setup. Therefore, the method further comprises the steps of:
handing over an Assertion by a Receiver Framework to any other entity;
signing an Agreement about the hand-out and/or hand-over of an Assertion;

requesting an Assertion; and
a Donor service enabler checking the validity of a received Assertion with a Donor Framework.

An additional advantage can be achieved when the method also comprises a step of creating in the first (Receiver) domain a Service Enabler Proxy arranged to act as a proxy for communicating with an instance of a selected second service capability feature at a service enabler of the second (Donor) domain. An additional advantage of such a Service Enabler Proxy is to enforce local policies, in this case in the first (Receiver) domain.

In this method, a step of creating a Service Enabler Proxy automatically in a first Framework of a first (Receiver) network domain may include a step of obtaining service information at the first (Receiver) network domain from a second (Donor) network domain for at least one element of service information selected from a group of elements that comprises: service type, service properties and service interface.

Alternatively in this method, the step of creating a Service Enabler Proxy in a first (Receiver) network domain may include a step of downloading source code or run-time code from a second (Donor) domain. The downloaded code may include local policy enforcement rules, for example by allowing the first (Receiver) domain to add source code containing the local policy, or by having in the run-time code downloaded from the second (Donor) domain references to policies stored in a local policy server. In the latter case the first (Receiver) domain just has to make sure the downloaded code is configured such that it can consult the local policy server.

In addition, one can also register a Service Enabler of the second (Donor) domain to the framework of the first (Receiver) domain and allow both domains to setup policies and have these policies enforced by the Service Enabler. The method allows that Service Enabler Proxies are created by the first (Receiver) Framework for each client application or that one main Service Enabler Proxy exists in the first (Receiver) domain that spawns off instances for each client application when requested by the first (Receiver) Framework.

### BRIEF DESCRIPTION OF DRAWINGS

The features, objects and advantages of the invention will become apparent by reading this description in conjunction with the accompanying drawings, in which:

FIG. 1 illustrates a basic overview of the technical field where the present invention applies, an standard interface between the service network and the core network.

FIG. 2A represents a simplified OSA/PARLAY architecture interacting with a Home Public Land Mobile Network.

FIG. 2B shows another view of an OSA/PARLAY architecture where an organization is responsible for the core network domain, whereas another organization is responsible for providing end-user services through partners.

FIG. 2C illustrates the role of Enterprise Operator that represents a domain itself intended for creating Service Agreements in a network operator domain on behalf of Application Providers.

FIG. 3A presents a scenario according to current art where a first domain can not offer Service Capabilities of a second domain to its client applications under conditions of Service Agreement between domains.

FIG. 3B presents a scenario according to current art where a first domain can not offer Service Enablers of a second domain to its application providers under conditions of the Service Agreement between both domains.

FIG. 4 illustrates a compacted architecture wherein a virtual global framework may be built up by adding a new framework-to-framework interface for inter-working between service and core networks in a multiple network domain environment.

FIG. 5A shows a distributed architecture with a number of network domains supporting remote service execution in general and service roaming in particular by adding a new framework-to-framework interface for inter-working between service and core networks in a multiple network domain environment.

FIG. 5B shows a distributed architecture with a number of network domains, wherein a first network domain operator can offer to first application providers service capability features in Service Enablers of another network domain operator thanks to said new Framework-to-Framework interface.

FIG. 6 introduces basic and simplified steps for registration of frameworks, namely donor and receiver frameworks, and for advertising services available from the donor domain to the receiver domain.

FIG. 7A to 7F show a number of sequences followed under a detailed embodiment based on a Service Agreement Partitioning. In particular, FIG. 7A shows how Service Level Agreement may be advertised to receiver Frameworks. FIG. 7B shows how a Federation Service Profile may be created. FIG. 7C shows how a Federated SCF may be installed in a Receiver Framework. FIG. 7D shows how Federation Service Level Agreements may be signed. FIG. 7E shows how Application Service Level Agreements may be signed. FIG. 7F shows how Federation Service Level Agreements may be terminated.

FIG. 8A to 8D show a number of sequences followed for providing service access under a detailed embodiment based on a Proxy enabler model. In particular, FIG. 8A shows how a Proxy may be installed. FIG. 8B shows how an Application Service Level Agreement may be signed and the Proxy SCS relays requests to the actual SCS while enforcing the local policies of the receiver domain. FIG. 8C shows how a Service level Agreement may be terminated. FIG. 8D shows how the SCS may be registered as Proxy alternative.

FIG. 9A to 9E show a number of sequences followed under a detailed embodiment based on an exchange of Service Assertions. In particular, FIG. 9A shows how Service Types may be advertised to a receiver Framework. FIG. 9B shows how an Assertion Profile and Assertions may be created. FIG. 9C shows how the Donor Framework may hand out Assertions to a Receiver Framework. FIG. 9D shows how a Receiver Framework may hand over Assertions to an Application. FIG. 9E shows how a Receiver Application may practice an Assertion.

FIG. 10 illustrates a localization service related use case in a roaming environment, including some preferred embodiments in accordance with the invention.

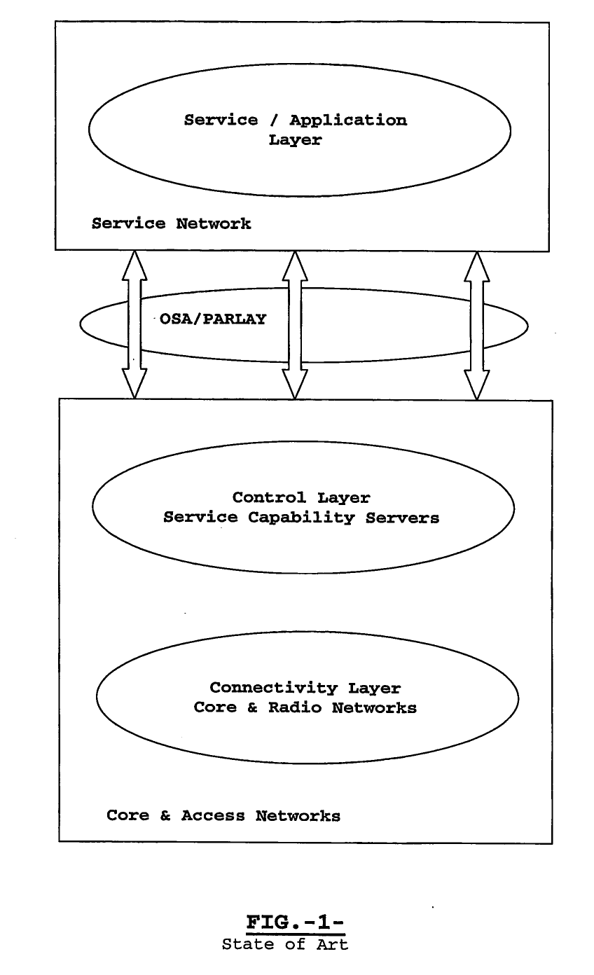

### DETAILED DESCRIPTION OF PREFERRED EMBODIMENTS

In accordance with a first aspect of the present invention, there is provided a number of currently preferred embodiments of a system and method for supporting the execution of a service application in a user's home network that makes use of network services from an heterogeneous visited network through an extended and improved OSA/PARLAY interface, wherein said user's home network and said heterogeneous visited network belong to different domain operators, and said network services are thus not explicitly registered in the user's home network.

Generally speaking and accordingly with a second aspect of the present invention, there is also provided a number of currently preferred embodiments of said system and method for allowing a second network domain, namely a Donor domain, to offer its own service capabilities toward a first domain, namely a Receiver domain, that in turn can offer these service capabilities to its own partners or service providers.

There are provided as well particular embodiments, that, in accordance with the present invention, are shared by the above two previous aspects to allow the capture of agreements and the exchange of security assertions between different networks and domains; as well as to enforce them on run-time.

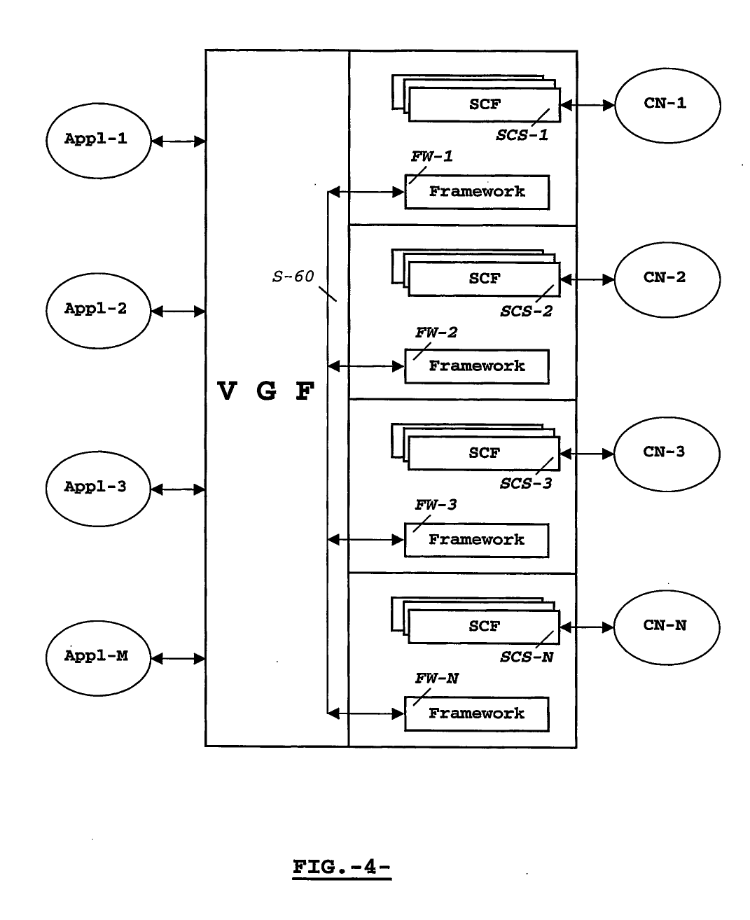

A particular architecture overview, in accordance with another aspect of the invention, is shown in FIG. 4 to illustrate how a Virtual Global Framework (hereinafter referred to as VGF) may be built up for inter-working between the service and core networks in a multiple network domain environment by adding a new framework-to-framework interface. Such new framework-to-framework interface (S-60) allows client applications (Appl.1; Appl.2; Appl.3; Appl.M) having an access to particular service capability features (SCF) in concerted service capability servers (SCS-1; SCS-2; SCS-3; SCS-N) to interact with respective core networks (CN-1; CN-2; CN-3; CN-N).

A Virtual Global Framework (VGF) is thus built up by including a number of local Frameworks (FW-1; FW-2; FW-3; FW-N) and a Framework-to-Framework interface (S-60), each local Framework locally serving a particular network domain for controlling access to service capability features (SCF) in service capability servers (SCS-1; SCS-2; SCS-3; SCS-N) of such network domain.

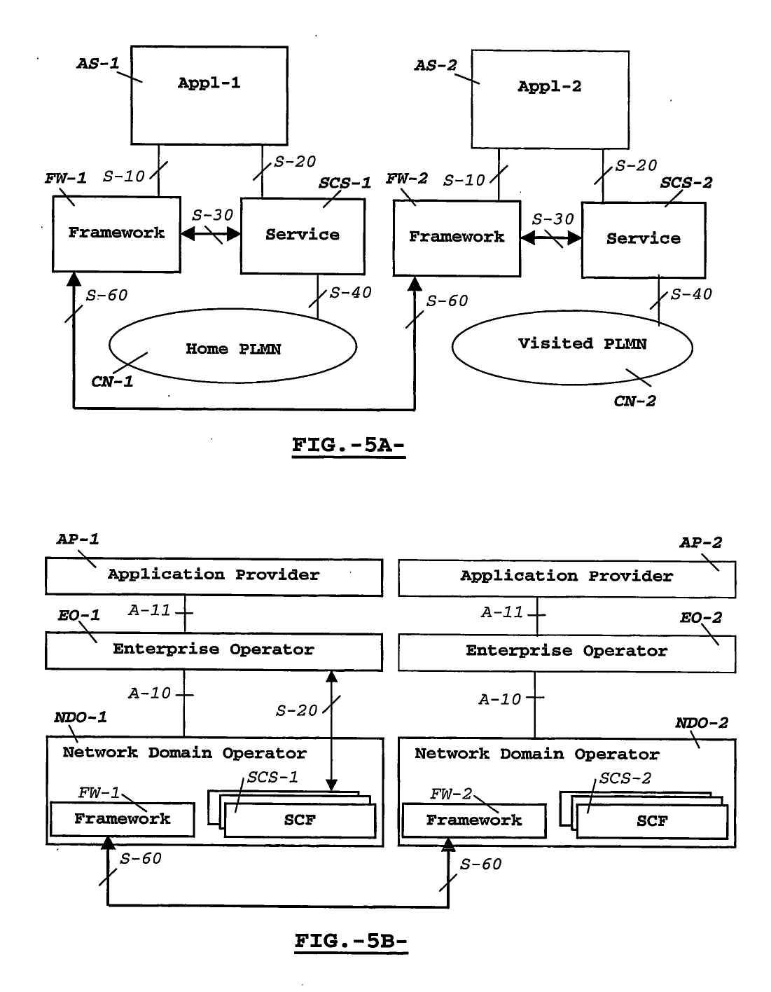

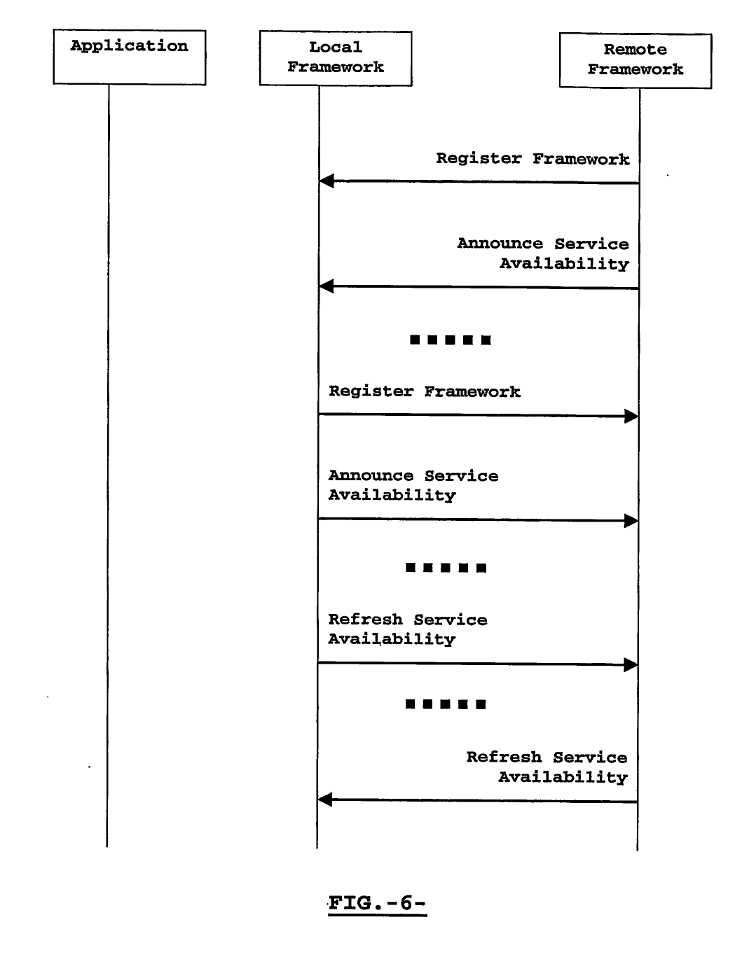

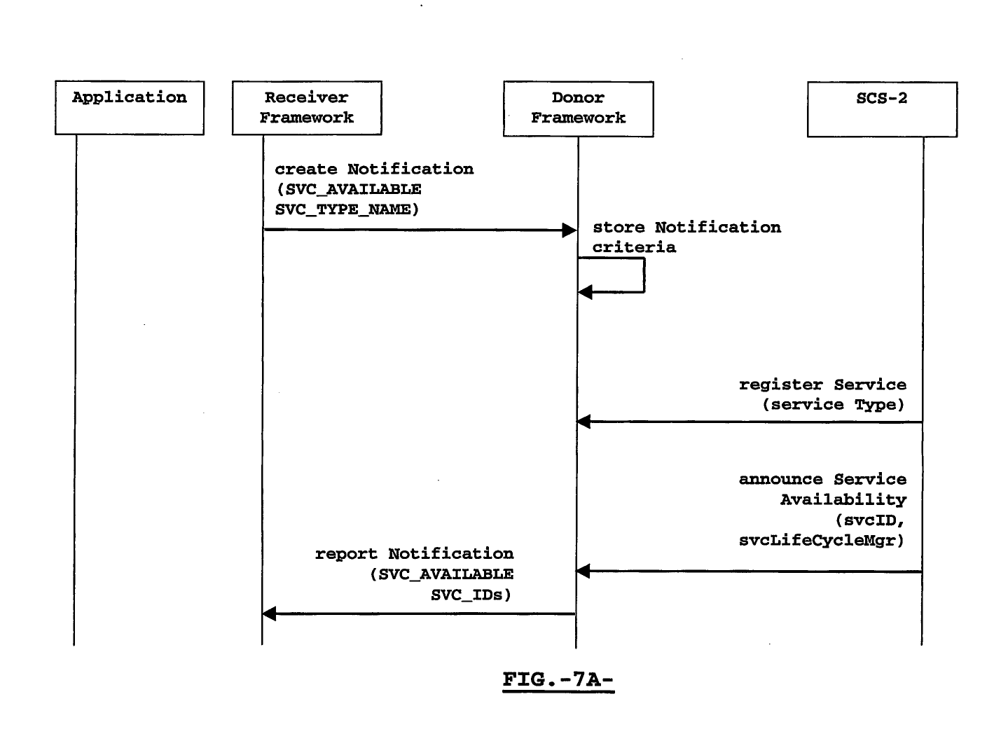

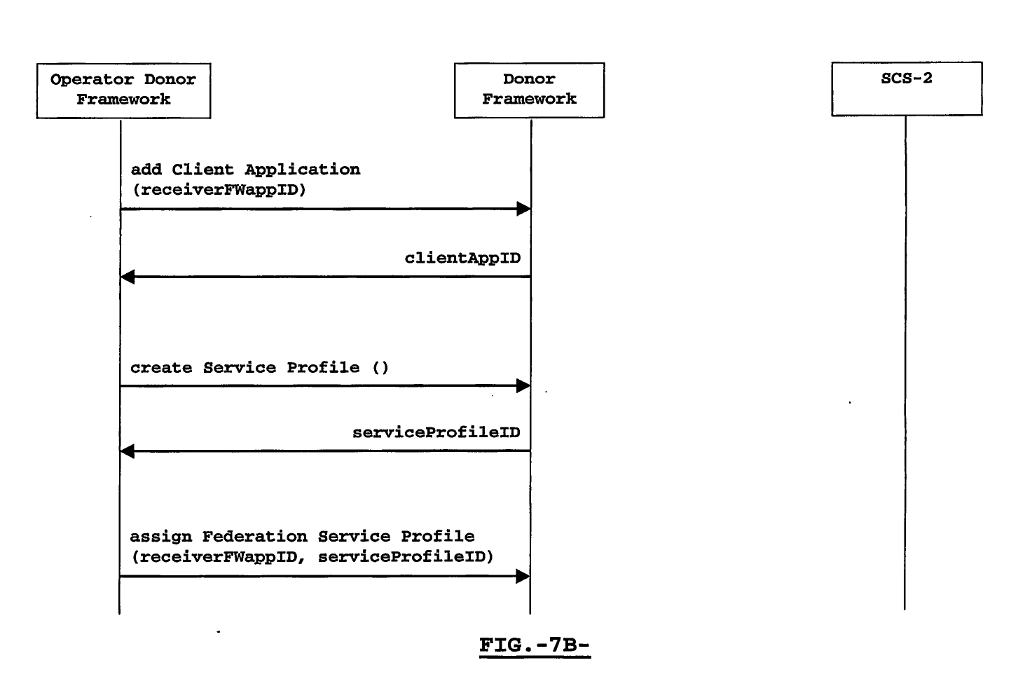

This VGF, and rather the new Framework-to-Framework interface (S-60) provided in accordance with the invention, generally allows remote service invocation and, more particularly, sharing services among different network domains and offering service network roaming under an OSA/PARLAY coverage. For example, FIG. 5A shows an architecture supporting said remote service invocation in general, whilst applied in particular to offering core network services when the subscriber is roaming in a visited Public Land Mobile Network (PLMN). Also for example, FIG. 5B illustrates how a network domain operator (EO-1) can offer to application providers (AP-1), with which a service agreement (A-11) has been signed, service capability features (SCF) in Service Enablers, namely service capability servers (SCS-2), of another network domain operator thanks to said new Framework-to-Framework interface (S-60).

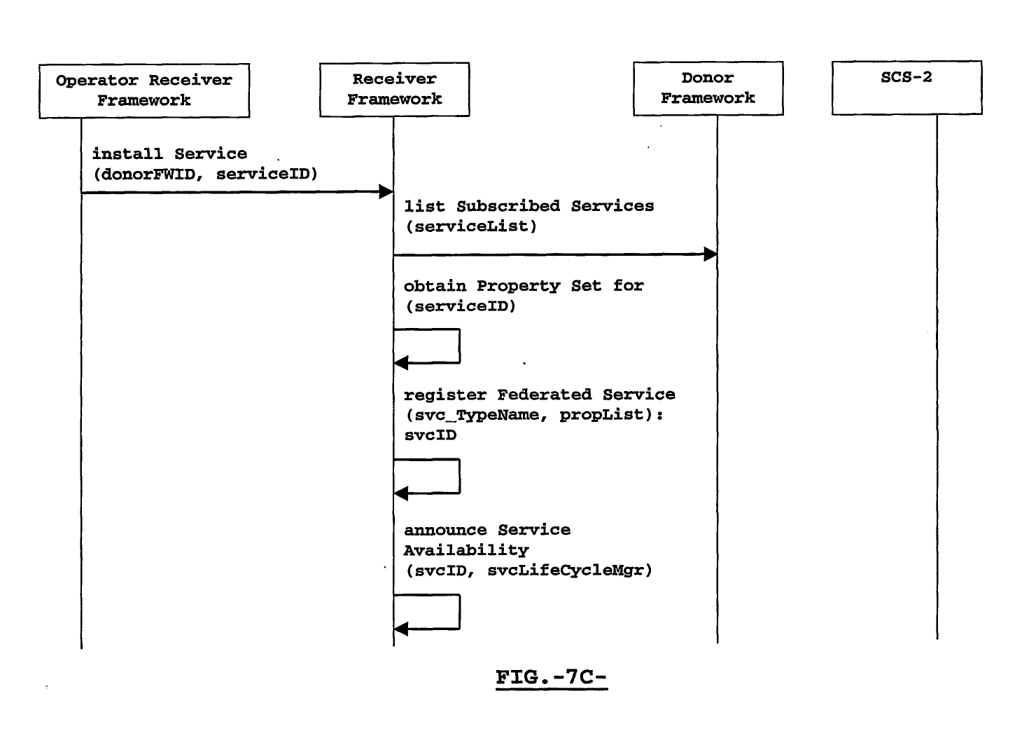

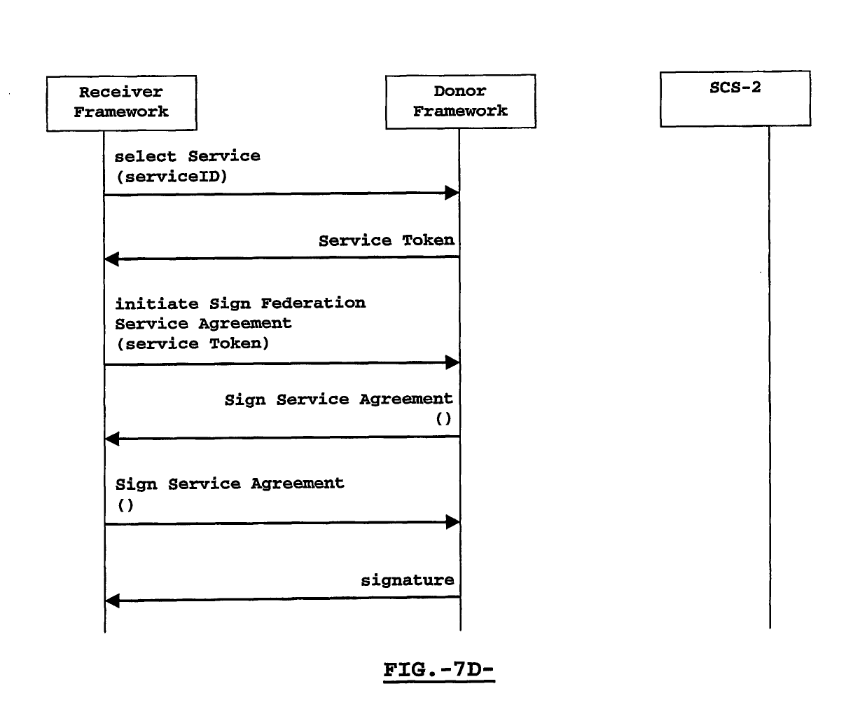

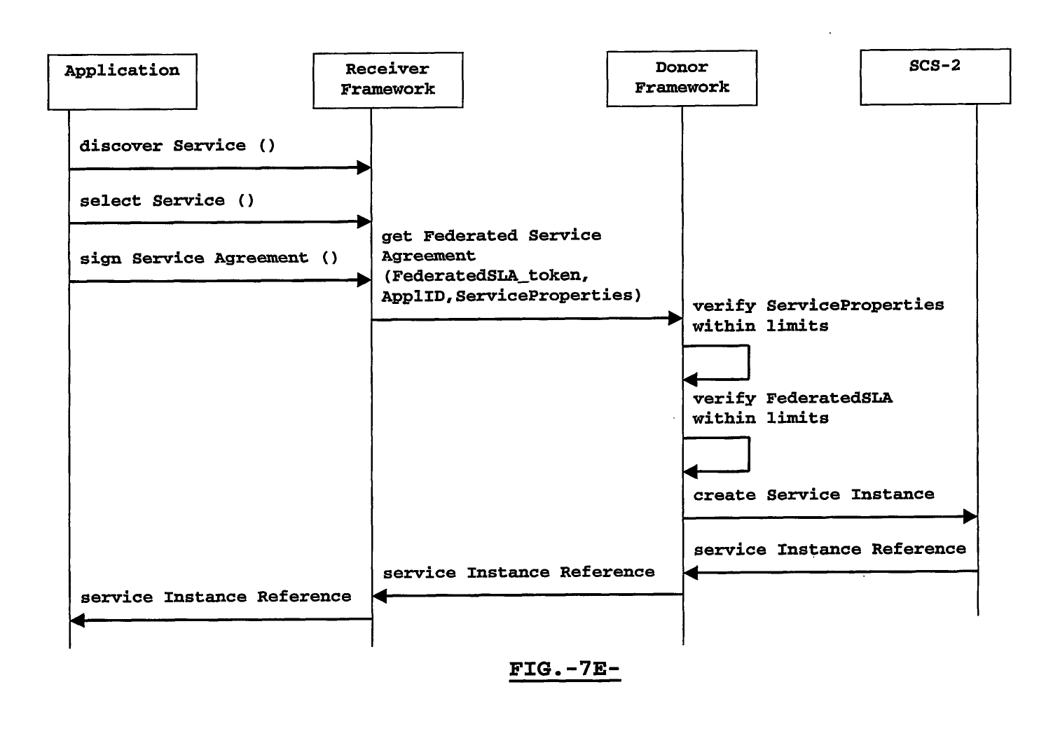

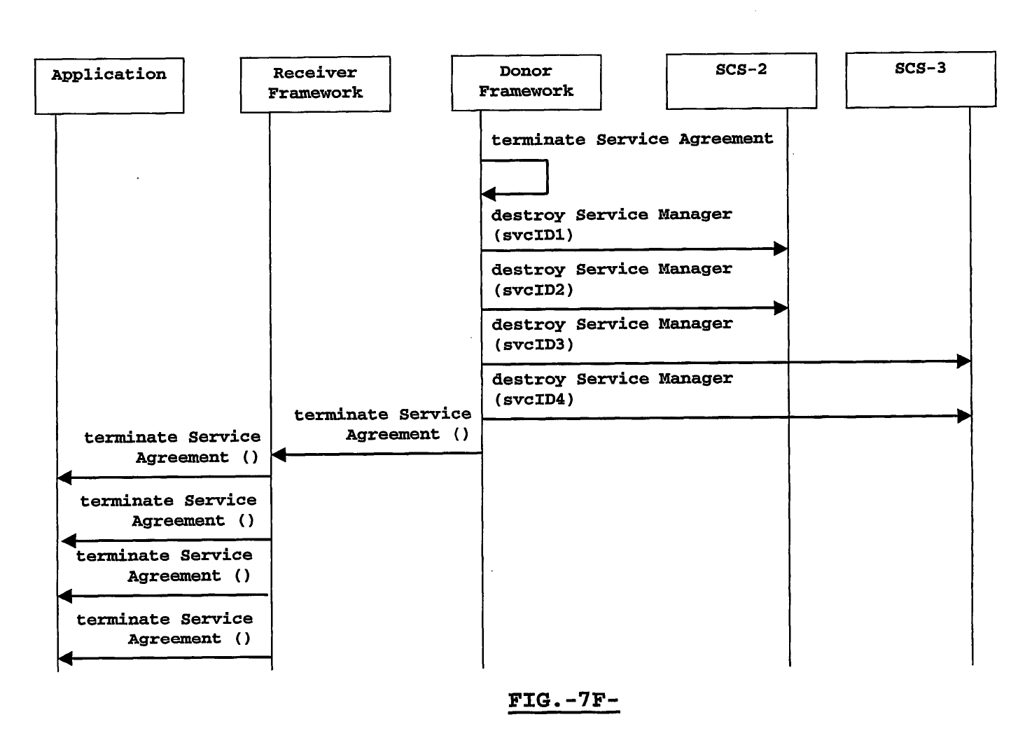

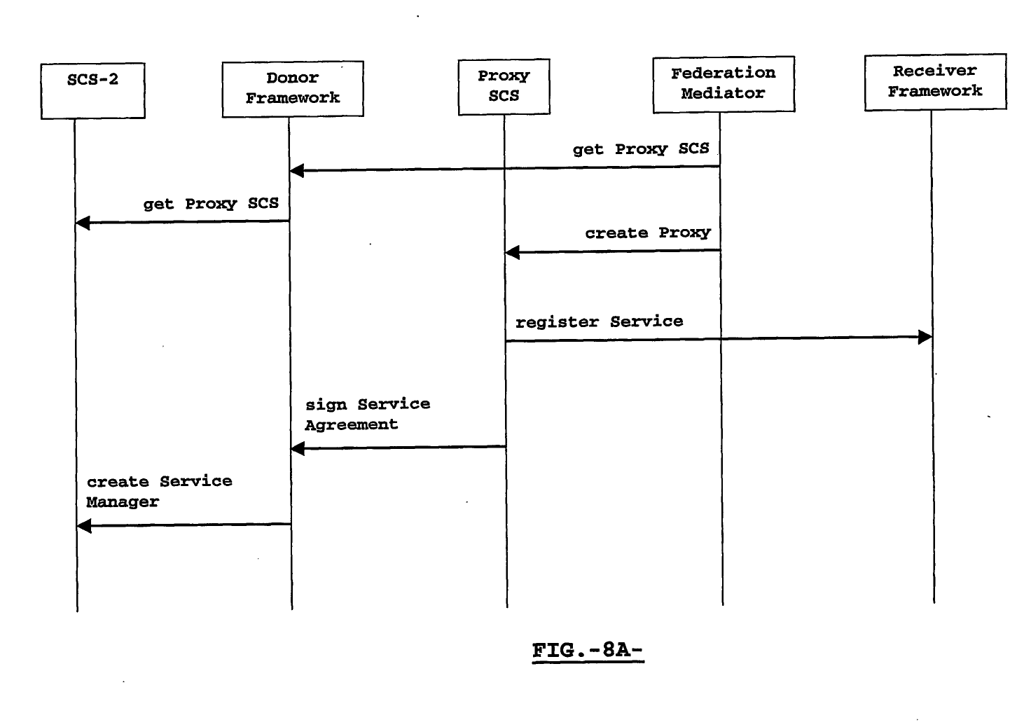

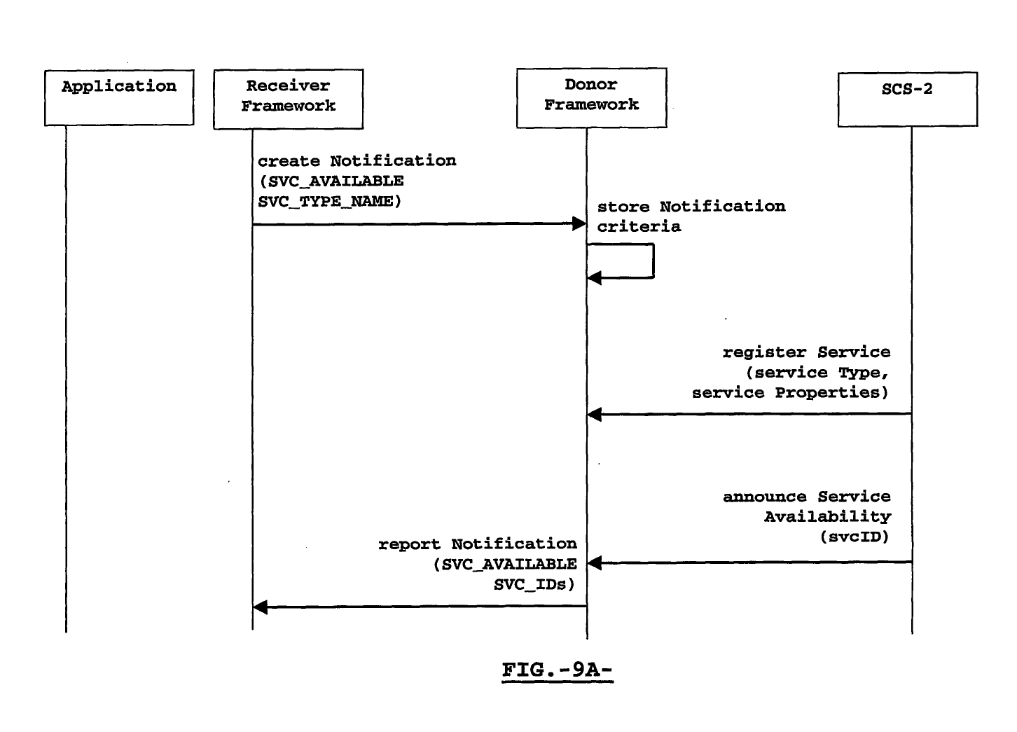

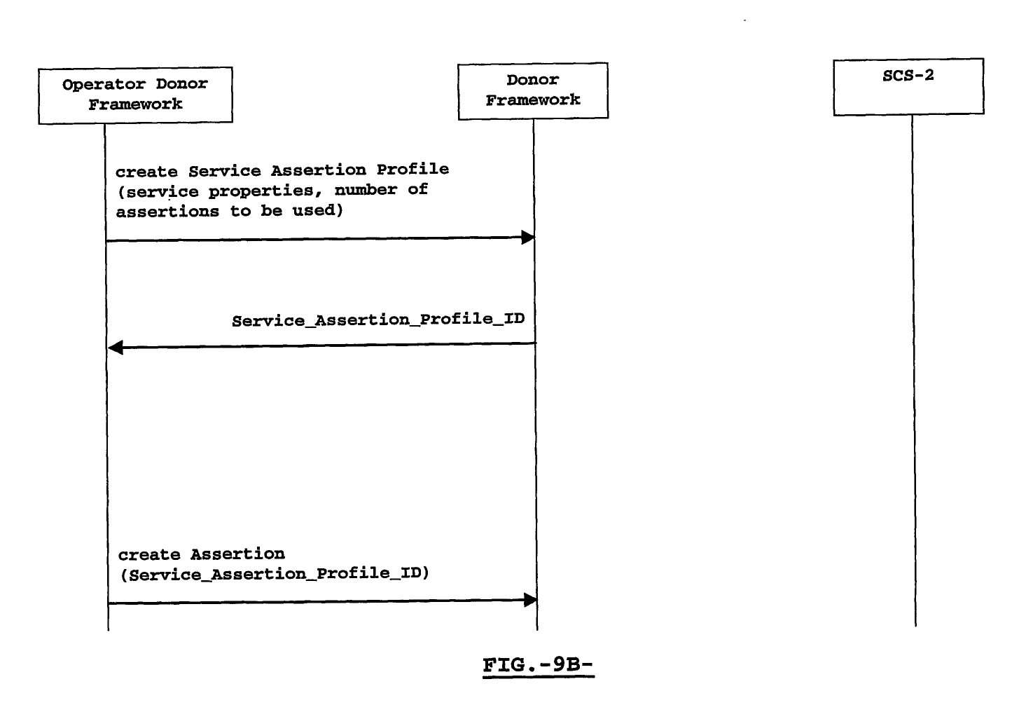

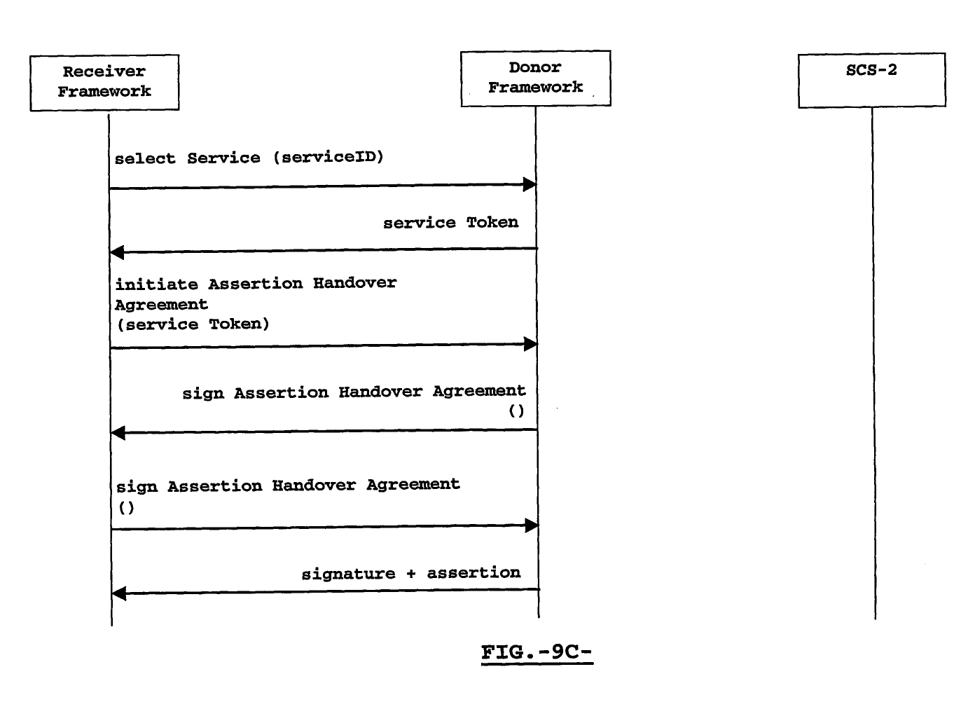

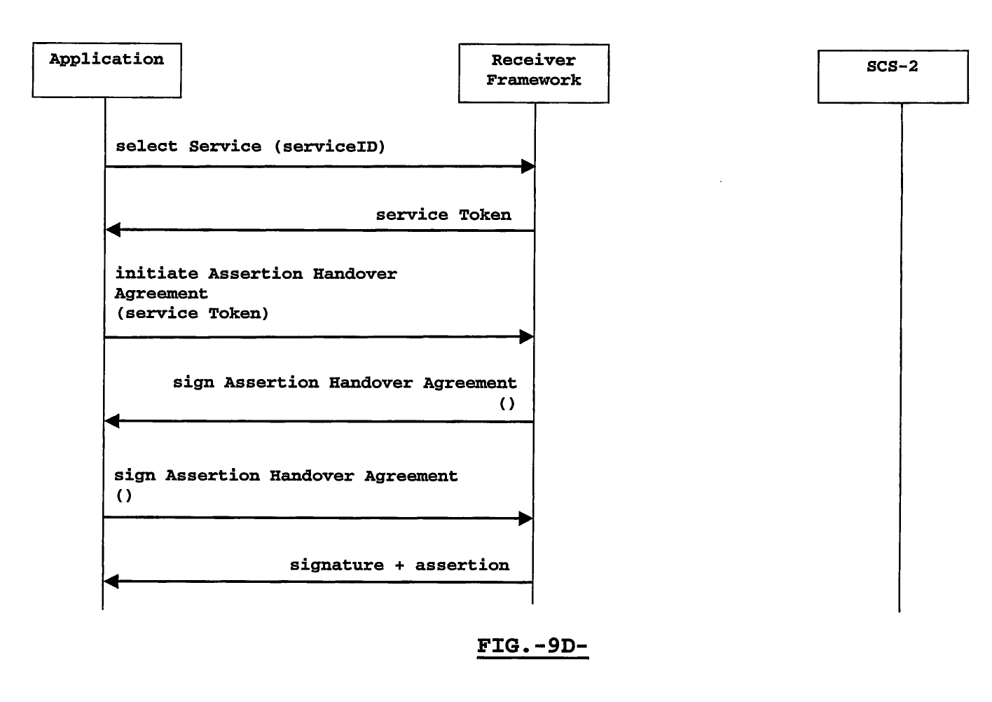

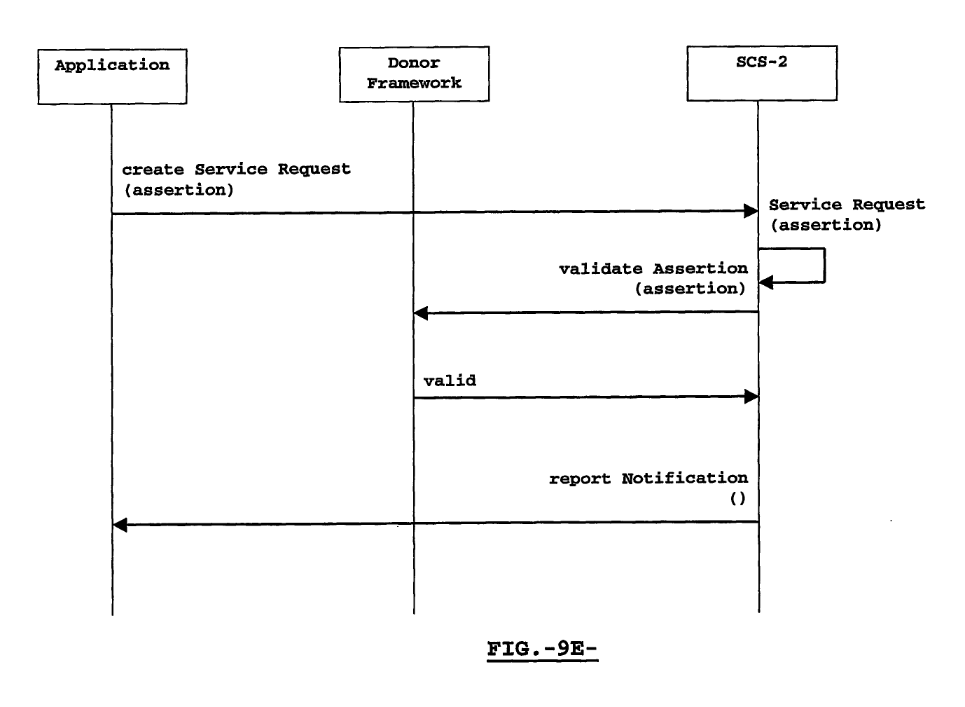

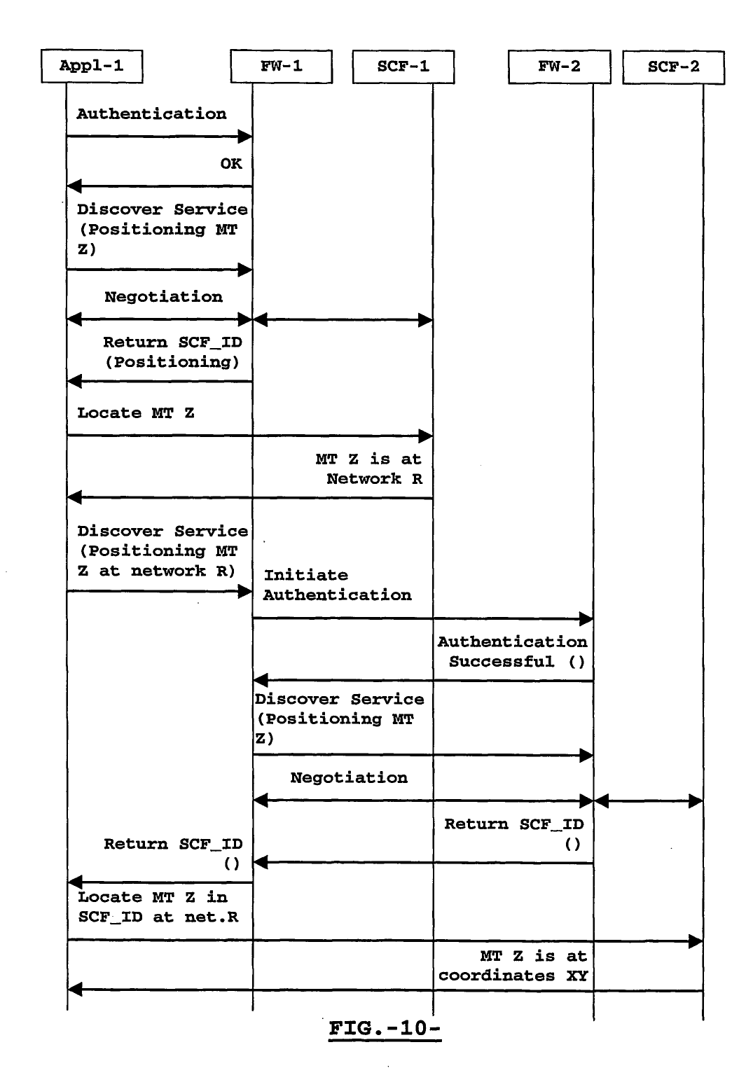

In accordance with another aspect of the present invention, the Framework-to-Framework interface (S-60) presents two main operation modes, on-line and off-line modes. An on-line mode is preferably carried out for those procedures where a first framework in a first domain serving a client application prepares the access to, and effectively access to, a second framework in a second domain where a service is invoked. Exemplary embodiments preferably carried out in an on-line mode might be those presented in FIGS. 7E and 7F, FIGS. 9D and 9E, and FIG. 10, for instance. On the other hand, an off-line mode is preferably used for frameworks exchanging and refreshing information about their respective services under particular service agreements, and respective interface protocols, required for certain communications. Exemplary embodiments preferably carried out in an off-line mode might be those presented in FIG. 6, FIG. 7A to 7C, and FIG. 9A to 9B, for instance.

For the sake of simplicity, a preferred and quite simplified exemplary embodiment for the on-line mode operation can be better described with regard to FIG. 5A. Thus, a first Client Application (Appl-1) requests (S-10) a particular service to its local framework (FW-1). The local framework (FW-1) checks (S-30) whether the service can be fully and validly carried out only with participation of service enablers of its own domain, namely service capability servers (SCS-1) of such own domain, and the client application is appropriately informed (S-10; S-20). If another network domain must be involved in the invocation of such requested service (SCS-2), the client application (Appl-1) requests (S-10) the local framework (FW-1) to access such service in the corresponding remote domain. Then, the local framework (FW-1) initiates (S-60) security management mechanisms with the remote framework (FW-2) in order to further allow the use of a remote service (SCS-2) by the local requester client application (Appl-1). Both local (FW-1) and remote frameworks (FW-2) negotiate (S-60) the service capabilities required and select (S-60) the most appropriate participation of a remote Service Capability Feature (SCF). Once a particular service has been instanced at the service enabler (SCS-2), the remote Framework (FW-2) communicates to the local framework (FW-1) the instance identity of the service, which is then provided to the requester client application (Appl-1) by its local framework (FW-1). The requester client application is thus enabled for eventually connecting with the remote SCF about the service.

On the other hand, another simplified exemplary embodiment for the off-line mode operation can be better described with regard to FIG. 6 that shows the exchanging and refreshing of information among frameworks about respective services, including respective registration.

First of all, the register phase among different Frameworks, as FIG. 6 shows, can be summarised into two basic and simplified steps. A first step of registration advertises the existence of a new framework, namely the Remote or Donor framework, that can be accessed by the framework of the operator owning the application, that is, the Local or Receiver framework. A second step of service announcement, further detailed in view of alternative preferred embodiments shown in FIGS. 7A and 9A, publishes available services and interfaces that will allow the Local or Receiver Framework to access said services in the Remote or Donor Framework.

The new Remote or Donor Framework references, as well as the available services on a per remote framework basis, are preferably stored in the Local or Receiver Framework as FIGS. 7A and 7C show in respect of an alternative embodiment wherein a registration of Frameworks is actually triggered from the respective domain operator.

However, other additional advantages may be obtained when a particular service capability feature (SCF), dedicated or not, is used to this end. In accordance with another embodiment of the present invention further explained in an exemplary use case illustrated in FIG. 10, the available services on a per remote framework basis, or references thereof, are preferably stored in a particular service capability feature (SCF-1) residing in a service enabler (SCS) under the Local or Receiver Framework access control.

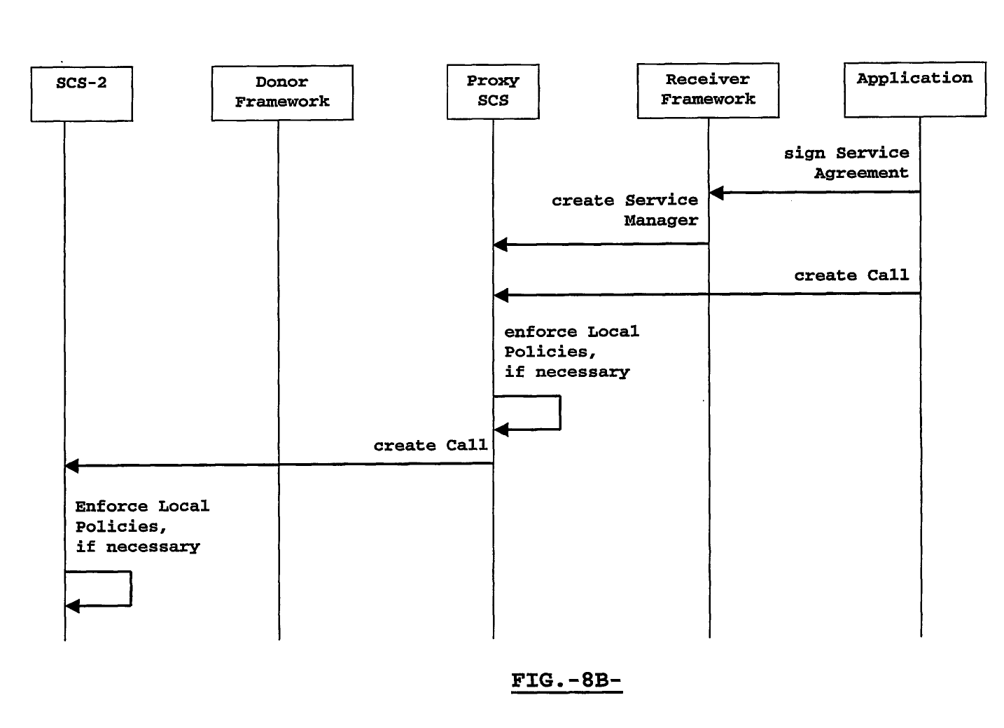

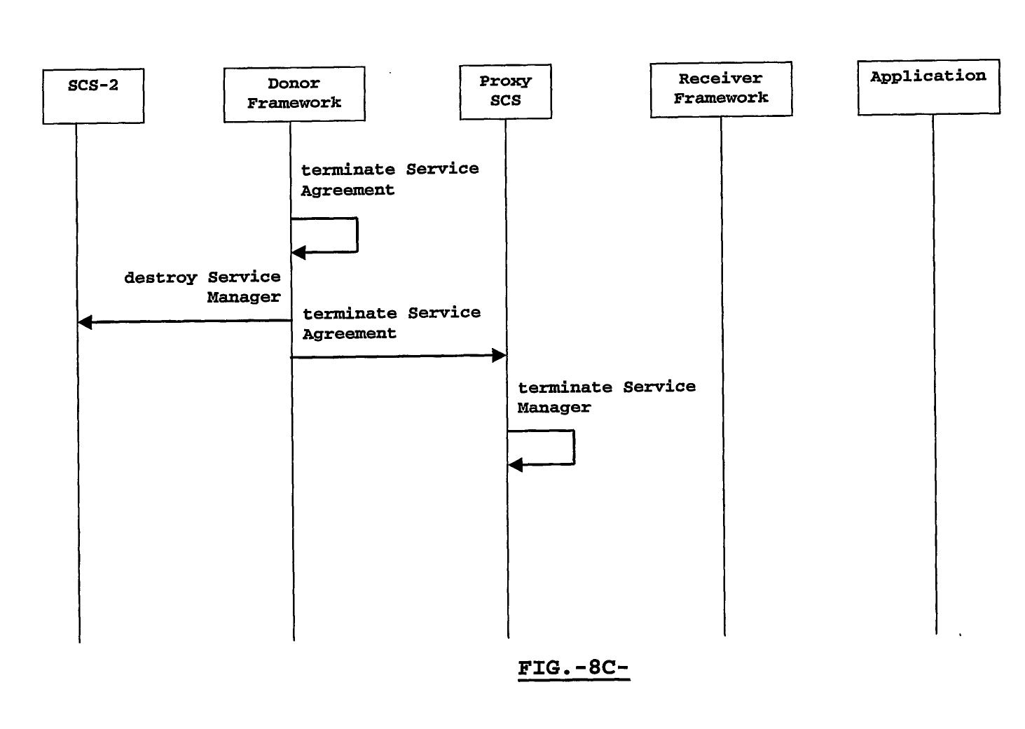

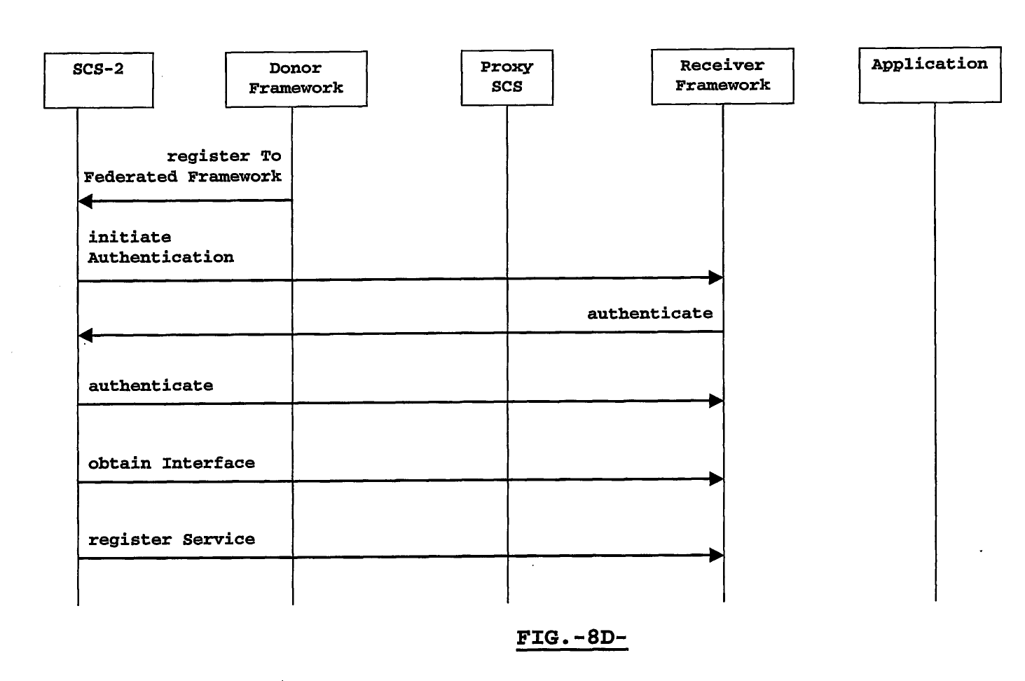

More particularly, an alternative further detailed embodiment is presented in view of FIG. 8A to 8D wherein this SCS is actually acting as a Proxy Service Enabler (Proxy SCS) interposed between a receiver domain and a donor domain, and intended for acting as a Proxy for service requests from applications (Appl-1; Application) in the receiver domain toward service enablers (SCS-2) of the donor domain as well as communications in the opposite direction. This another embodiment makes the frameworks work in a more standard way and, as shown in FIG. 10, always contacting (S-30) service capability features (SCF-1) at a particular service enabler (SCS), likely an SCS

Proxy, in a receiver domain for selecting appropriate service capability features (SCF-2) of a donor domain to deal with the client application for a particular service.

Independently of whether the available services, or references thereof, on a per remote framework basis are stored in the local framework, or in a particular service capability feature (SCF) under control of said local framework, or in an Proxy Service Enabler interposed between donor and receiver domains, when a framework (Local; Remote; Donor) adds or changes services, said framework sends an update of such services to associate frameworks (Remote; Local; Receiver), as FIG. 6, 7A and 9A illustrate.

Different use cases may be described following this for some of the above embodiments. Nevertheless, a use case of particular relevance is a localization service, which in accordance with some embodiments of the present invention is suitable for solving an exemplary problem commented above. Thus, FIG. 10 illustrates this use case for localization services in a roaming environment, wherein a client application (Appl-1) carries out the required security management mechanisms for authentication with the local framework (FW-1) in a first domain of reference where appropriate service agreements exist. Then, the client application (Appl-1) requests a discovering process for an interface to available service capability features toward the local framework (FW-1). The local framework (FW-1) initiates a negotiation with the set of service capability features (SCF-1) in a service capability server (SCS) of this first domain, selects an appropriate SCF_ID to deal with the requested service, and returns such SCF_ID reference as the resulting Discovery interface that the application uses to request for the particular service, namely positioning SCF, along with the special capabilities that the application (Appl-1) needs.

During the above security management mechanisms, the local framework (FW-1) checks whether the application (Appl-1) is allowed to use the SCF and under what policy criteria. This may be captured in the so-called Service Level Agreement (SLA) between the domain network operator and service provider. In case the application is allowed to use an SCF, the local framework (FW-1) returns identities of all the service capability features, all SCF_ID's, that might fulfill the needs of the client application (Appl-1). Next, the application selects one of these SCF_ID's, and the SCS then creates and SCF instance that is to be used by this application and is also able to check the conditions. The reference of this SCF instance is returned to the framework (FW-1), and the framework returns such reference to the application (Appl-1). From this moment on the application is able to use this SCF (SCF-1).

The application (Appl-1) asks to the SCF instance resulting Discovery interface (SCF-1) for localization of the mobile terminal “Z” (MT Z). Said SCF instance (SCF-1) detects that the MT Z is localized at network R. In other words, the first domain determines that service capability features at a second network domain, namely at network R, are available for the requester application. This response is sent back to the application (Appl-1). The application requests to the local framework (FW-1) about the possible access to remote service capability features at said remote network domain. In particular, by using the alternative embodiment of an SCS Proxy anticipated above and further described in detail, service capability features (SCF-1) in a receiver domain may be contacted for selecting appropriate service capability features (SCF-2) of a donor domain to deal with the client application for a particular service.

At this stage, the local framework (FW-1) initiates corresponding security management mechanisms with a remote framework (FW-2) in a second domain of reference where appropriate service agreements exist. Upon successful result of an applicable security management mechanism under service agreement premises a remote process can be initiated from the local framework (FW-1) toward the remote framework (FW-2) for the latter (FW-2) discovering service capability features (SCF-2) that are available for use by the requester application (Appl-1) in said second network domain. Such security management mechanism can be carried out in terms of Service Level Agreement partitions as shown in FIGS. 7D and 7E, or in terms of Assertion validity criteria as shown in FIG. 9C.

Therefore, the local framework (FW-1) requests to the remote framework (FW-2) about service capability features (SCF-2), which may be located in a service capability server or service enabler (SCS-2) at the second domain, for the localization service. The local framework (FW-1) selects one of the available visited service capability features (SCF-2) as requested by the application (Appl-1) and negotiates specific capabilities through the remote framework (FW-2), since the local framework knows about the application needs, and the remote framework is the one having such capabilities registered. The visited service capability server (SCS-2) then creates an instance of the visited service that is going to be used by the client application (Appl-1) in the first domain. A reference to this instance is returned from the remote framework (FW-2) to the local framework (FW-1), and the local framework returns it to the application (Appl-1).

From this moment on the client application (Appl-1) is able to use the visited service capability features (SCF-2), and the process has been managed between the local and remote frameworks.

A main advantage of this aspect in accordance with the invention is that a client application only contacts with its local framework each time it wants to access a service, whilst the framework manages the following process and the relationship with other federated OSA/PARALAY environments. The client application is thus only registered in one framework and does not need be registered in all the federated domains.

Complementarily, there is provided a number of embodiments in accordance with an above second aspect of the present invention, and still accomplishing other objects of the invention. In this respect, three detailed embodiments are intended for allowing a second network domain, namely a donor domain, to offer its own service capabilities toward a first network domain, namely a receiver domain, that in turn can offer these service capabilities to its own partners or service providers, whilst allowing every domain to install and enforce its policies. Each of these three detailed embodiments offers particular embodiments for other specific aspects depending on specific advantages that might be sought.

A first detailed embodiment is presented in FIG. 7A to 7F, and provides for extending the existing Service Agreement model, thus allowing a Receiver Domain to ‘partition’ the Service Agreement between a Donor and said Receiver domain. The partitions make up the Service Agreements between the receiver domain and its application providers. Further explanations are provided for this first detailed embodiment, which is hereinafter referred to as the Service Agreement Partitioning embodiment. A second detailed embodiment is illustrated in FIG. 8A to 8D, and provides for having a model where the Receiver Domain has a so-called Proxy Enabler (Proxy SCS) preferably for each Service Enabler of a Donor Domain. Further explanations are also provided for this second detailed embodiment, which is hereinafter referred to as the Proxy embodiment. A third detailed embodiment in FIG. 9A to 9E provides additional advantages by replacing the current Service Agreement model by an Assertion-based model. Further explanations are provided for this third detailed embodiment as well, which is hereinafter referred to as the Service Assertion embodiment.

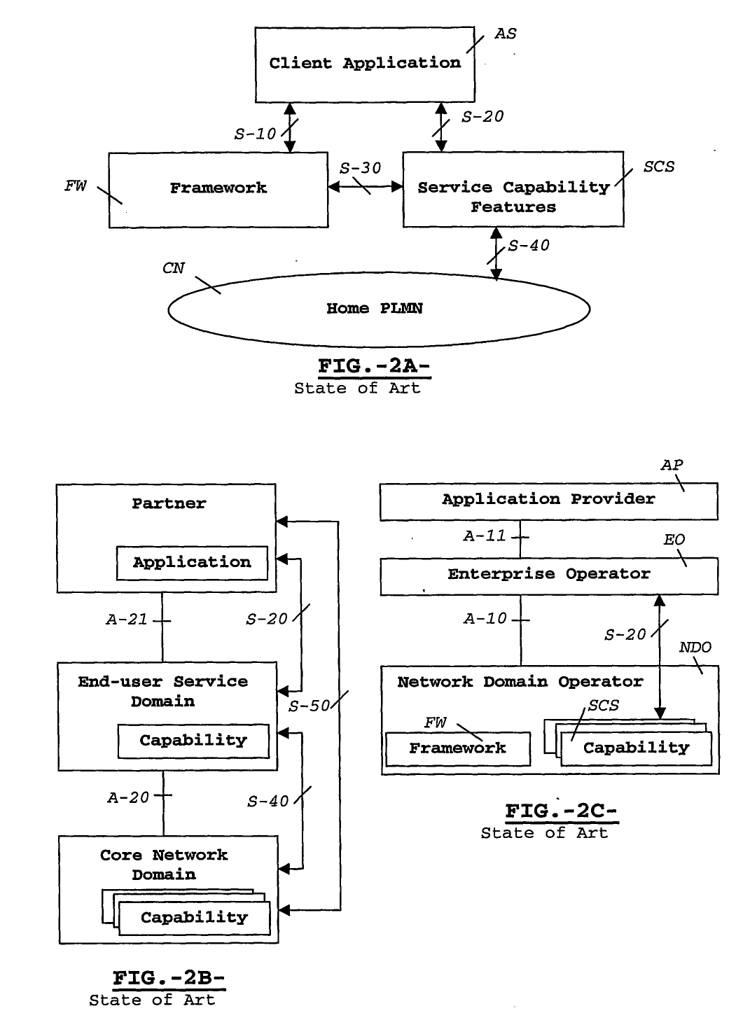

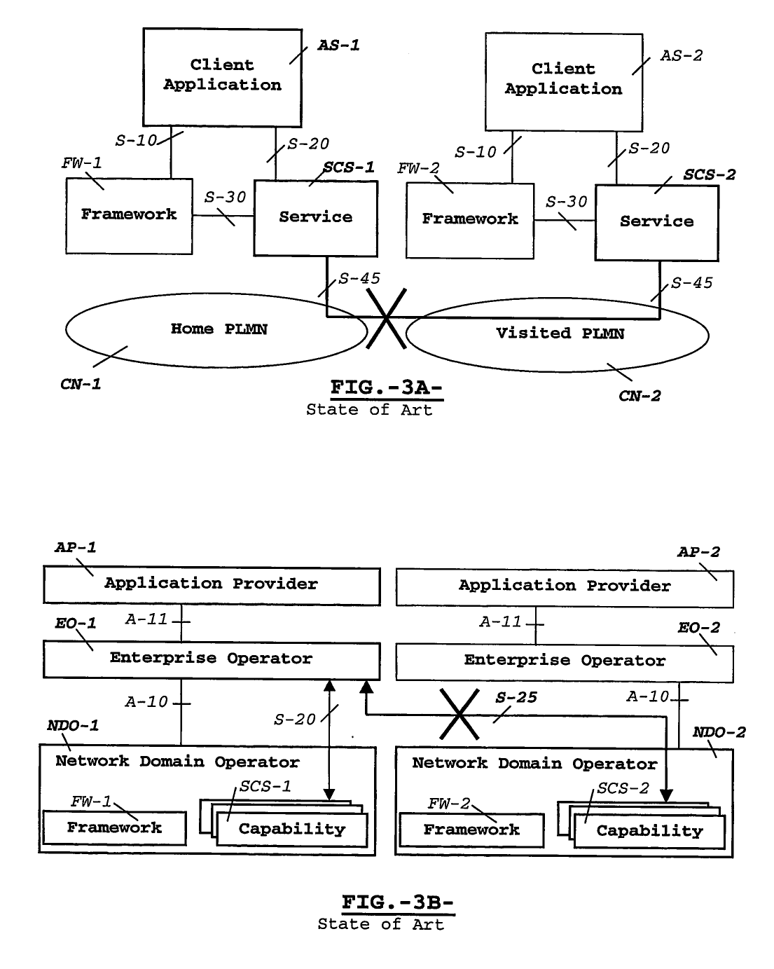

Under the Service Agreement Partitioning embodiment an OSA/PARLAY Framework in the Donor Domain (hereinafter the Donor Framework) can advertise Service Enablers (SCS-2) to applications that subscribed for notifications thereof in said donor domain, using existing mechanisms as shown in FIGS. 2A and 2C, for instance. In accordance with a detailed embodiment of the present invention, already mentioned above in respect of FIG. 6 and now detailed with regard to FIG. 7A, not only such applications but also an OSA/PARLAY Framework in a Receiver Domain (hereinafter the Receiver Framework) can be notified of said Service Enablers (SCS-2) in the Donor Domain. Thus, when a Receiver Domain offers Service Enablers (SCS-2) from a Donor Domain to the Receiver Domains partners (Application), these two domains are said to form a Federation. In a similar manner, when a Receiver Framework offers Service Enablers (SCS-2) that are advertised by a Donor Framework, the two frameworks are said to be working in a Federation setup.

A Donor Framework in a Federation setup under this Service Agreement Partitioning embodiment is thus responsible for:
advertising new registered Service Enablers to those Receiver Frameworks registered in said Donor Framework, as shown in FIG. 7A after having registered the receiver framework with the off-line operation mode described above with regard to FIG. 6, or with an operator related procedure as the one shown in FIG. 7B;
providing a mechanism whereby a Receiver Framework can sign a Federation Service Agreement, which can be regarded as a contract between the donor and the receiver frameworks on the terms under which the receiver framework and its partners can use a specific Service Enabler, as shown in FIG. 7D; and for
providing a mechanism whereby a Receiver Framework can request a Receiver Application Service Agreement from the Donor Framework for one of the Receiver Framework partner's applications within the limits set by the Federation Service Agreement, as included in FIG. 7E.

The terms of the Receiver Application Service Agreement are constructed by the Receiver Framework whereas the Donor Framework ensures that the requested Receiver Application Service Agreement is within the limits set by the terms of the Federation Service Agreement. The Receiver Application Service Agreement can be seen as a partition of the Federation Service Agreement given to a specific application. When a Receiver Application Service Agreement is given out to the Receiver Framework a new service instance is created and a reference is given to the Receiver Framework, as appearing in FIG. 7E and already commented above with reference to the use case shown in FIG. 10 as well.

On the other hand, a Receiver Framework in a Federation setup under this Service Agreement Partitioning embodiment is responsible for registering Service Enablers of the Donor Domain, which were advertised by a Donor Framework and can be also referred to as Donor Services, and make them available for own applications, as shown in FIG. 7C. Therefore, a list of properties for an advertised Service Enabler are retrieved from the Donor Framework.

In addition to these several embodiments within the detailed Service Agreement Partitioning embodiment, dedicated Service Profiles can be created for the Donor Services as for any other service in the receiver's domain as presented in FIG. 7B. In this respect, such service profiles may adopt the form of, or may be stored in, a dedicated Service Capability Feature in the receiver domain as commented above in view of the use case illustrated in FIG. 10.

Further, when a Receiver Application selects such a Donor Service and signs a Service Agreement with the Receiver Framework within the applicable security management mechanism in the receiver domain, said Receiver Framework requests the Donor Framework for a Receiver Application Service Agreement as a part of the corresponding security management mechanisms between donor and receiver domains. The Receiver Framework provides in this request the terms and/or restrictions that are defined in the Service Profile assigned to said Receiver Application. Then, the Donor Framework makes use these terms and/or restrictions to construct a Receiver Application Service Agreement, as the sequence diagram in FIG. 7E illustrates and as also considered in the use case shown in FIG. 10.

Moreover, FIG. 7F shows a nowadays preferred embodiment to terminate from the donor domain serving a receiver domain with own Donor Services. Although not drawn in any figure, a similar procedure might be triggered from the receiver domain as well.

Under the Proxy embodiment there is provided a so-called Proxy Service Enabler (Proxy SCS) interposed between a Receiver Domain and a Donor Domain for accessing those Service Enablers (SCS-2) in the Donor Domain. More specifically, an actual first Service Enabler (Proxy SCS) is present to act within the Receiver Domain as a proxy for requests from applications in the Receiver domain to a second Service Enabler (SCS-2) in the Donor Domain, and likewise in the other direction from said second Service Enabler to the applications. From the viewpoint of such second Service Enabler in the Donor Domain, the first Service Enabler (Proxy SCS) is regarded as an application.

Moreover, as shown in FIG. 8A and FIG. 8B, a Proxy Service Enabler (Proxy SCS) in the Proxy setup is responsible for communicating with actual Service Enablers (SCS-2) in the Donor Domain, for acting as a proxy for requests from applications of the Receiver Domain, and for relaying said applications to the actual Service Enabler (SCS-2) in the Donor Domain. Furthermore, the Proxy Service Enabler (Proxy SCS) is responsible for enforcing policies or Agreements between application providers and the Receiver Domain.

A Donor Framework in a Proxy setup is responsible for advertising new registered services to registered Receiver Frameworks. In this respect, the aforementioned methods already commented under the Service Agreement Partitioning embodiment for mutual registrations between donor and receiver frameworks, as illustrated in FIGS. 6 and 7A, may also apply under this Proxy embodiment. Moreover, as further described in an alternative embodiment the Donor Framework may optionally provide. Service Enabler code to the Receiver Domain so that the corresponding Service Enabler can be instantiated and optionally tuned to enforce local policies in said Receiver Domain.

On the other hand, a Receiver Framework in a Proxy setup is responsible for registering Proxy Service Enablers (Proxy SCS) and for making them available for own client applications in the Receiver Domain. Therefore, a number of alternatives are suggested in accordance with this Proxy embodiment to create a Proxy Service Enabler.

In a first alternative embodiment for creating a proxy, a Proxy Service Enabler is created in the first (Receiver) domain for communicating with an instance of a selected second service capability feature at a service enabler of the second (Donor) domain. The main advantage of such a Service Enabler Proxy is to enforce local policies, in this case in the first (Receiver) domain. The Proxy Service Enabler can be created automatically in the first (Receiver) domain based on information received from the second (Donor) domain about at least one element selected from a group of elements that comprises: service identifier, service type, service availability, service properties and service interface.

In a second alternative embodiment for creating a proxy, a Proxy Service Enabler is created in the first (Receiver) domain by downloading source code or run-time code from the second (Donor) domain. This code can be such that it is tuned to include local policy enforcement rules.

For example by allowing the first (Receiver) domain to add source code containing the local policy, or by having in the run-time code downloaded from the second (Donor) domain references to policies stored in a local policy server. In the latter case the first (Receiver) domain just has to make sure the downloaded code is configured such that the local policy server can be consulted.

In a third alternative embodiment for creating a proxy, a Proxy Service Enabler is created in the first (Receiver) domain by selecting a Service Enabler (SCS) in the second (Donor) domain, by registering this Service Enabler (SCS) to the framework of the first (Receiver) domain for acting as Proxy Service Enabler, and by allowing the Service Enabler (SCS) to setup policies for both domains and have these policies enforced. The Proxy Service Enabler may be constructed based on Service Type and property values of the real Service Enabler (SCS) in the second (Donor) domain. In this respect, construction of a Proxy Service Enabler may be a responsibility of a dedicated component such as represented in FIG. 8A with a so-called Federation Mediator. More particularly, the introduction of said Proxy Service Enabler may be a responsibility of a Receiver Framework. Still further, a particular Service Enabler in the Donor Domain may register in the Receiver Framework, and thus register in the Receiver Domain, to fulfill the role of Proxy Service Enabler as FIG. 8D shows.

Still addressing features under the Proxy embodiment, FIG. 8C shows an exemplary embodiment of how a Service Agreement can be terminated under the Proxy embodiment.

A third detailed embodiment, the aforementioned Service Assertion embodiment, is found to offer additional advantages over the two previous ones. This Service Assertion embodiment is based on exchanging and practising service Assertions between a Donor and a Receiver Domain.

Under this Service Assertion embodiment, an OSA/PARLAY Framework in the Donor Domain (Donor Framework) can advertise services (Donor Services) to applications that had subscribed for notifications thereof in said Donor Domain and, according to FIG. 9A, can also advertise these Donor Services to an OSA/PARLAY Framework in the Receiver Domain (Receiver Framework) in like manner as anticipated above for the Service Agreement Partitioning embodiment, as illustrated in FIGS. 6 and 7A.

Therefore, FIG. 9C shows how the Receiver Framework may request the hand out of a service Assertion by the Donor Framework. The process as such is comparable to the one shown in FIG. 7D though rather oriented to the replacement of a Service Agreement model by an Assertion-based model. Generally speaking, an Assertion is an authorization and/or an authentication statement, and it can contain a number of attributes. In particular, Assertions may be considered as included in security management mechanisms.

Thus, in accordance with FIG. 9C, a Donor Framework hands out a service Assertion to a Receiver Framework as carrying out security management mechanisms between said Donor and Receiver Frameworks. In like manner, FIG. 9D shows how a corresponding service Assertion is handed out by a Receiver Framework to any other requesting entity, such as a client Application in a Receiver Domain, when carrying out security management mechanisms between said Receiver Framework and said client Application.

Conceptually, a service Assertion describes an Agreement between an application and a specific service. An Assertion can be sent to the service from a certain entity and then the service becomes available for such entity having sent the Assertion. Such Assertion ‘sending’ may be regarded in this context as ‘practicing’ the Assertion. When the Assertion is issued, it is not known yet which application or entity is going to practice that Assertion.

The Receiver Framework can advertise its obtainable Capabilities, which are represented by an Assertion, and hand over the Assertion to an application inside or outside the Receiver Domain. This application can then either practice the Assertion, or hand the Assertion over to another application. This way, Agreements accompanied with authorization rights, which are set forth to use a service according to said Agreements, can be exchanged in a very flexible manner.

Additionally, an entity handing over an Assertion, such as an application for example, can add authentication, authorization, or attribute data to the Assertion. This way, such application can customize the Assertion. Each domain handing over an Assertion can hand out additional data and associate said additional data to the Assertion. For example, the stated Capabilities can be extended or restricted with own Capabilities, thus resulting a sort of layered Assertion.

A Donor Framework in a Federation setup under this Service Assertion embodiment is thus responsible for:
creating service Assertions that represent the agreement and rights for Donor Service usage as FIG. 9B shows, or with the above off-line operation mode illustrated in FIG. 6;
advertising new registered services, or rather new service enablers (SCS-2) as FIG. 9A shows;
providing a mechanism for handing out a service Assertion to a Receiver Framework as included in FIG. 9C, the mechanism may involve signature by both parties of a statement that the Assertion is exchanged and non-repudiation can be proved, if necessary, and preferably the Assertion or parts thereof being encrypted;
keeping track of Assertions handed out to registered Receiver Frameworks as well as to local applications residing at the Donor Domain; and
handling requests for checking validity of a practiced Assertion, such requests generally sent by Donor Services or, more particularly, by a service manager entity preferably located in a service enabler (SCS-2) as shown in FIG. 9E, wherein the Donor Framework checks whether the Assertion has not been practiced before.

In accordance with a general principle supported by the present invention, an Assertion can only be practiced once. The Donor Framework indicates to a service manager entity, which is preferably located in the service enabler (SCS-2), whether the Assertion is still valid or not. Nevertheless, the service enabler can have its own mechanism to check the validity of the Assertion without involving the framework, as anyone skilled in the art may appreciate.

On the other hand, a Receiver Framework in a Federation setup under this Service Assertion embodiment is responsible for:
requesting handout of a service Assertion to a Donor Framework as illustrated in FIG. 9C, wherein the mechanism for obtaining such Assertion may include the signature by both parties, as already commented above, of a statement indicating that the Assertion is exchanged and that non-repudiation can be proved, if necessary, the Assertion or parts thereof being preferably encrypted;
advertising newly obtained Capabilities to applications in a Receiver Domain, and likely also outside said Receiver Domain;
adding to the Assertion data for at least one element of a group of elements that comprises authentication, authorization and attribute data in order to create a ‘layered’ Assertion;
providing an Assertion to the Donor Service, namely ‘practicing’ the Assertion, what typically happens when the Receiver Framework acts as a representative for the Receiver Domain, Receiver Domain intended to act as an enabler or middle layer towards other partner domains for shielding Capabilities of the Donor Domain; and
handing over a service Assertion to an application in a Receiver Domain upon request from such application as illustrated in FIG. 9D, the mechanism may involve the signature by both parties, as already commented above, of a statement indicating that the Assertion is exchanged and that non-repudiation can be proved if necessary, the Assertion or parts thereof being preferably encrypted.

In this respect, when the Receiver Framework has handed over a service Assertion it is no longer allowed to practice the Assertion itself, but just the application having received the Assertion in the Receiver Domain can then practice such Assertion, or hand it over to an other application.

Eventually, a service enabler (SCS) in a Donor Domain is responsible for:
registering itself with the Donor Framework;
validating whether an assertion has been signed by the Donor Framework and, optionally, whether the assertion was or not modified;
requesting a Donor Framework, upon reception of an Assertion for the first time, to validate whether the Assertion had been handed out by said Donor Framework and whether the assertion is still valid; and
upon acceptation of the assertion by the Donor Framework or by the service enabler itself, granting the practitioner access to its service according the Agreement properties described in the assertion.

The invention is described above in respect of several embodiments in an illustrative and non-restrictive manner. Obviously, many modifications and variations of the present invention are possible in light of the above teachings. The scope of the invention is determined by the claims with due regard to the specification and drawings, and any modification of the embodiments that fall within the scope of these claims is intended to be included therein.

1. A telecommunications system arranged for providing client service applications with access to service capability features via a standardized interface, the system comprising:
a number of application servers where providing client service applications;
a number of first service enablers where first service capability features are specified in a first network domain;
a first Framework for providing a controlled access to said first service capability features;
a number of core network elements;
a number of second service enablers where second service capability features are specified in a second network domain;
a second Framework for providing a controlled access to said second service capability features;
wherein said first Framework is arranged for communicating with said second Framework for accessing said second service capability features specified in said number of second service enablers of said second network domain.

2. The telecommunications system of claim 1, wherein the first and second Frameworks comprise protocol means for allowing a framework-to-framework communication.

3. The telecommunications system of claim 2, wherein said protocol means includes means for advertising toward a first framework in a first network domain the existence of a second framework in a second network domain with which service capability features can be shared.

4. The telecommunications system of claim 3, wherein said protocol means includes means for advertising from a second framework in a second network domain towards a first framework in a first network domain that service capability features can be offered from service enablers of said second network domain to client applications of said first network domain.

5. The telecommunications system of claim 3, wherein the means for advertising towards a first framework the existence of a second framework includes means for the second framework registering itself in the first framework.

6. The telecommunications system of claim 3, wherein the means for advertising towards a first framework in a first domain the existence of a second framework in a second domain includes means for the operator of said first domain registering the second framework in the first framework.

7. The telecommunications system of claim 4, wherein the means for advertising service capability features that can be offered from service enablers of a second network domain includes means for notifying from a second framework in said second network domain towards a first framework in a first network domain at least one element of service information selected from a group of elements that comprises:
service identifier, service type, service availability, service properties and service interface.

8. The telecommunications system of claim 7, wherein the means for advertising the existence of service capability features available at service enablers of a second network domain includes means for creating, from a first framework in a first network domain toward a second framework in a second network domain, criteria for notification of such element of service information.

9. The telecommunications system of claim 1 further comprising means for carrying out security management mechanisms between a first framework in a first network domain and a second framework in a second network domain.

10. The telecommunications system of claim 9, wherein the means for carrying out security management mechanisms between said first and said second frameworks includes means for capturing service agreements between first and second domains, the service agreements representing a policy applied between said first and second domains.

11. The telecommunications system of claim 9, wherein the means for carrying out security management mechanisms between said first and said second frameworks includes means for handing over service assertions and signatures.

12. The telecommunications system of claim 1 further comprising means for discovering service capability features available at service enablers of a second network domain between a first framework in a first network domain and a second framework in a second network domain.

13. The telecommunications system of claim 12, wherein the means for discovering available service capability features between said first framework and said second framework includes means for negotiating specific capabilities as required by a client application in a first domain.

14. The telecommunications system of claim 13, further comprising means for returning from a second framework in a second network domain towards a first framework in a first network domain a reference to a service instance created at a service enabler of said second network domain, for allowing an application in the first network domain make use of corresponding service of the second network domain.

15. The telecommunications system of claim 1 further comprising a Service Enabler Proxy interposed between a first domain and a second domain and intended for acting as a Proxy for service requests from applications in the first domain toward service enablers of the second domain as well as communications in the opposite direction.

16. The telecommunications system of claim 15, wherein said Service Enabler Proxy is provided in a first domain and comprises a number of dedicated service capability features of said first domain for storing references of corresponding service capability features of a second domain.

17. The telecommunications system of claim 15, further comprising means for creating a Service Enabler Proxy automatically in the first domain based on information received from a framework in a second domain, said information including at least one element of service information selected from a group of elements that comprises: service type, service properties and service interface.

18. The telecommunications system of claim 15, further comprising means for downloading source code or run-time code from the second domain intended to create a Service Enabler Proxy in the first domain.

19. The telecommunications system of claim 15, wherein a particular service enabler of a second domain is registered in a first framework of a first domain for acting as a Service Enabler Proxy towards a second domain.

20. The telecommunications system of claim 1, wherein the first network domain includes a Home core network of a user whereas the second network domain includes a Visited core network where the user is roaming.

21. A method of providing client service applications with access to service capability features via a standardized interface, the method comprising the steps of:
(a) registering first service capability features in a first network domain with a first Framework and second service capability features in a second network domain with a second Framework;
(b) carrying out security management mechanisms for authentication and authorization of a number of players selected from a group that includes user, network, a requester application, and combinations thereof, in each network domain through each respective Framework; and
(c) discovering first service capability features that are available for use by a requester application in said first network domain;
(d) determining in the first network domain that service capability features at a second network domain may be available for the requester application;
(e) carrying out security management mechanisms for authentication and authorization from a first Framework of said first network domain, through a second Framework of said second network domain; and
(f) discovering second service capability features that are available for use by said requester application in said second network domain.

22. The method of claim 21, wherein the step of determining that service capability features are available at a second network domain includes a step of requesting to the first Framework in the first network domain for an access to the second service capability features available in the second network domain for the requester application.

23. The method of claim 22, wherein the step of determining that second service capability features are available at a second network domain includes a step of receiving such information from a first service capability feature selected in the first network domain.

24. The method of claim 21, wherein the step of discovering second service capability features that are available in the second network domain comprises a step of negotiating capabilities from the first Framework of the first network domain with the second Framework of the second network domain.

25. The method of claim 24, wherein the step of negotiating capabilities includes a step of creating an instance of a selected service capability feature at a service enabler of a second domain, and a step of returning back a reference to such instance from the second Framework of the second network domain to the first Framework of the first network domain.

26. The method of claim 21, further comprising a step of registering a second Framework of a second network domain with a first Framework of a first network domain.

27. The method of claim 26, wherein the step of registering frameworks includes a step of registering the second Framework itself in the first Framework, and another step of registering the first Framework itself in the second Framework.

28. The method of claim 26, wherein the step of registering frameworks includes a step where the operator of a second (Donor) network domain registers a first Framework of a first network domain in a second Framework, and another step where the operator of a first network domain registers a second Framework of a second network domain in a first Framework.

29. The method of claim 26, further comprising a step of publishing at least one interface that allows said first and said second Frameworks to access the service capability features respectively controlled by each other.

30. The method of claim 21, further comprising a step of exchanging information between a first and a second Framework about available service capability features in a first and a second network domain respectively, with or without explicit indication of the interface required to access such service capability features.

31. The method of claim 30, further comprising a step of indicating to at least one first service capability feature in a first network domain the at least one second service capability feature available in a second network domain, and vice versa.

32. The method of claim 21, further comprising a step of capturing Service Level Agreements between the network operator of a network domain and a service provider of a requester application.

33. The method of claim 32, further comprising a step of capturing Service Level Agreements between a first and a second network domains through corresponding first and second Frameworks.

34. The method of claim 33, wherein said Service Level Agreements are extended between second domains and first domains in a telecommunication network with multiple domains, the method further comprising the steps of:
creating and assigning a Federation Service Profile on a Donor Framework;
signing a Federation Service Agreement on a Donor Framework;
installing in a Receiver Framework necessary information about a Donor Service for a client application being able to discover the Donor Service; and
requesting a Receiver Application Service Agreement within the bounds of a Federation Service Agreement from a Donor Framework.

35. The method of claim 34, wherein a Receiver Application Service Agreement serves as a partition of a Federation Service Agreement.

36. The method of claim 21, wherein the steps of carrying out security management mechanisms include the steps of handing out and handing over an Assertion that gives a practitioner the right to use a service in a federated framework setup.

37. The method of claim 36, further comprising the steps of:
handing over an Assertion by a Receiver Framework to any other entity;
signing an Agreement about the hand-out and/or hand-over of an Assertion;
requesting an Assertion; and
a Donor Service Enabler checking the validity of a received Assertion with a Donor Framework.

38. The method of claim 21, further comprising a step of creating in a first domain a Service Enabler Proxy arranged to act as a proxy for communicating with an instance of a selected second service capability feature at a service enabler of the second domain.

39. The method of claim 38, further comprising a step of enforcing service agreements and policies at the Service Enabler Proxy.

40. The method of claim 38, wherein the step of creating a Service Enabler Proxy in a first Framework of a first network domain includes a step of obtaining service information at the first network domain from a second network domain for least one element of service information selected from a group of elements that comprises: service type, service properties and service interface.

41. The method of claim 38, wherein the step of creating a Service Enabler Proxy in a first Framework of a first network domain includes a step of downloading source code or run-time code from a second domain.

42. The method of claim 41, wherein the step of downloading source code or run-time code includes a step of downloading local policy enforcement rules.

43. The method of claim 38, wherein the step of creating a Service Enabler Proxy in a first Framework of a first network domain includes a step of registering a Service Enabler of a second domain in the first Framework of the first domain where both domains are allowed to set-up agreements and policies that need to be enforced by the Service Enabler.

44. The method of claim 38, wherein a Service Enabler Proxy is created by the first Framework for each client application.

45. The method of claim 38, wherein the step of creating a Service Enabler Proxy in a first Framework of a first network domain includes a step of creating instances of said Service Enabler Proxy for each client application.
